(19) United States
(12) Patent Application Publication
(10) Pub. No.: US 2016/0232369 A1
(43) Pub. Date: Aug. 11, 2016

(54) Managing Access To Images Using Roles

(71) Applicants: Jayasimha Nuggehalli, Sunnyvale, CA (US); James Woo, Los Altos, CA (US); Bhushan Nadkarni, Santa Clara, CA (US)

(72) Inventors: Jayasimha Nuggehalli, Sunnyvale, CA (US); James Woo, Los Altos, CA (US); Bhushan Nadkarni, Santa Clara, CA (US)

(73) Assignee: RICOH COMPANY, LTD., Tokyo (JP)

(21) Appl. No.: 14/619,533

(22) Filed: Feb. 11, 2015

(51) Int. Cl. G06F 21/62; H04L 29/06; H04L 29/08

(52) U.S. Cl. CPC G06F 21/6218; H04L 67/06; H04L 67/42; H04L 63/102

(57) ABSTRACT

A reference image of one or more objects is displayed on the display of a mobile device in a manner that allows a user of the mobile device to simultaneously view the reference image and a preview image of the one or more objects currently in a field of view of a camera of the mobile device. An indication is provided to the user of the mobile device whether the camera of the mobile device is currently located within a specified amount of a distance at which the reference image was acquired. An image management application provides various functionalities for accessing and managing image sequences. Access to images, workflows and workflow levels is managed using roles. Users are assigned roles and are permitted to access images, workflows and workflow levels for which they have been assigned the required roles.

### RELATED APPLICATION DATA AND CLAIM OF PRIORITY

This application is related to U.S. patent application Ser. No. 14/543,712 (Attorney Docket No. 49986-0811) entitled IMAGE ACQUISITION AND MANAGEMENT, filed Nov. 17, 2014, and U.S. patent application Ser. No. 14/543,725 (Attorney Docket No. 49986-0817) entitled IMAGE ACQUISITION AND MANAGEMENT, filed Nov. 17, 2014, the contents all of which are incorporated by reference in their entirety for all purposes as if fully set forth herein.

### FIELD OF THE INVENTION

Embodiments relate generally to managing access to images and workflows using roles.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

An increasing number of mobile devices, such as smartphones and tablet computers, are equipped with cameras. This makes them increasingly valuable to individuals and businesses. One of the issues with mobile devices that include cameras is that when multiple images of the same object are captured over time, it can be difficult to analyze changes in the objects because the images may not have been captured at the same distance or angle. Thus, changes in the objects that may appear to have occurred based upon the images may not have actually occurred.

Another issue is that there is often no access controls applied to images acquired with mobile devices, or to workflows for processing images acquired with mobile devices, allowing third party access to sensitive information.

### SUMMARY

According to an embodiment, a network device includes one or more processors, one or more memories and an image management application configured to receive, over one or more communications links from a first client device that is external to the network device, image data and metadata for an image acquired by the first client device, wherein the metadata for the image specifies one or more logical entities for the image acquired by the first client device. In response to receiving, over the one or more communications links from the first client device that is external to the network device, the image data and the metadata for the image acquired by the first client device, wherein the image data specifies one or more logical entities for the image acquired by the first client device, the image management application stores the image data and the metadata for the image acquired by the first client device, receives, over the one or more communications links from a second client device that is external to the network device and different from the first client device, a request for a user to access the image data for the image acquired by the first client device and in response to receiving, over the one or more communications links from a second client device that is external to the network device and different from the first client device, a request for a user to access the image data and the metadata for the image acquired by the first client device, the image management application determines one or more logical entities assigned to the user, determines, based upon the one or more logical entities assigned to the user and the one or more logical entities for the image acquired by the first client device, whether the user is permitted to access the image acquired by the first client device and in response to determining, based upon the one or more logical entities assigned to the user and the one or more logical entities for the image acquired by the first client device, that the user is permitted to access the image acquired by the first client device, causes the image data and the metadata for the image acquired to the first client device to be transmitted to the second client device. In response to determining, based upon the one or more logical entities assigned to the user and the one or more logical entities for the image acquired by the first client device, that the user is not permitted to access the image acquired by the first client device, then the image management application does not cause the image data and the metadata for the image acquired to the first client device to be transmitted to the second client device.

### BRIEF DESCRIPTION OF THE DRAWINGS

In the figures of the accompanying drawings like reference numerals refer to similar elements.

FIG. 1 is a block diagram that depicts an arrangement for acquiring and managing images.

FIG. 2 is a flow diagram that depicts an approach for a mobile device to acquire images using a reference image as a background image and a distance at which the reference image was acquired.

FIG. 3A depicts an example reference image that includes one or more objects that are represented by different shapes.

FIG. 3B depicts a distance at which a reference image was acquired.

In FIG. 3C, a preview image is displayed on a mobile device display

FIG. 3D depicts a mobile device that has been positioned and oriented so that the one or more objects in a reference image and one or more preview images overlap

FIG. 4A depicts top-level information that includes a patient identification field (“ID Scan”), an anatomy identification field (“Anatomy ID”), a department field (“Department”), a status field (“Status”) and a registered nurse name (“RN—Name”).

FIG. 4B depicts that a user has used one or more controls (graphical or physical) on a mobile device to navigate to the department field.

FIG. 4C depicts the department options available to the user after selecting the department field and that the user has navigated to the Dermatology department option.

FIG. 4D depicts a graphical user interface allows the user to specify a wristband setting, a body part, a wound type and an indication of the seriousness of the injury.

FIG. 5A depicts a table of example types of memorandum data.

FIG. 5B is a table that depicts a textual representation of image data 552 that includes embedded audio data.

FIG. 6A depicts an example login screen that queries a user for user credentials that include a user login ID and password.

FIG. 6B depicts an example dashboard screen that provides access to various functionality for managing image data.

FIG. 6C depicts an example Approval Queue screen, or work queue, that allows a user to view and approve or reject images.

FIG. 6D depicts an example Rejected Image Processing screen that allows a user to view and update information for rejected images.

FIG. 7A is a table that depicts an example patient database, where each row of the table corresponds to a patient and specifies an identifier, a date of birth (DOB), a gender, an ID list, a social security number (SSN), a sending facility, a family name, a first (given) name and another given (middle) name.

FIG. 7B is a table that depicts an example patient database schema.

FIG. 8 depicts an example historical view screen generated by image management application.

FIG. 9 is a flow diagram that depicts an approach for managing access to images using logical entities.

FIG. 10 depicts a table of example types of memorandum data that may be included in the metadata for an image.

FIG. 11 depicts an example GUI screen after a user has been granted access to a requested image.

FIG. 12 depicts an example user table schema that defines an example data schema for users.

FIG. 13 depicts an example user table that specifies various types of user data.

FIG. 14 depicts an example GUI specifying user data.

FIG. 15 is a table that depicts four example levels of access to workflows and images.

FIG. 16A is a flow diagram that depicts an approach for managing access to a workflow using the access criteria for Level 1.

FIG. 16B is a flow diagram that depicts an approach for managing access to a workflow using the access criteria for Level 2.

FIG. 16C is a flow diagram that depicts an approach for managing access to a workflow using the access criteria for Level 3.

FIG. 16D is a flow diagram that depicts an approach for managing access to a workflow using the access criteria for Level 4.

FIG. 17 depicts an example user table that specifies various types of user data.

FIG. 18 depicts a table of example types of memorandum data that may be included in the metadata for an image.

FIG. 19 depicts an example workflow schema that defines an example data schema for workflows.

FIG. 20A depicts an example workflow for processing images.

FIG. 20B depicts an example workflow that includes all of the elements of the workflow of FIG. 20A, and also includes an additional Approval Queue at Level 3.

FIG. 20C depicts an example workflow that is the same as workflow of FIG. 20A, except that approved images are provided to storage instead of an EMR system.

FIG. 21 is a block diagram that depicts an example computer system upon which embodiments may be implemented.

### DETAILED DESCRIPTION

In the following description, for the purposes of explanation, numerous specific details are set forth in order to provide a thorough understanding of the embodiments. It will be apparent, however, to one skilled in the art that the embodiments may be practiced without these specific details. In other instances, well-known structures and devices are shown in block diagram form in order to avoid unnecessarily obscuring the embodiments.

I. OVERVIEW

II. SYSTEM ARCHITECTURE
A. Mobile Device
B. Application Server

III. ACQUIRING IMAGES USING A REFERENCE IMAGE AND DISTANCE

IV. MEMO AND AUDIO DATA

V. IMAGE DATA MANAGEMENT

VI. HISTORICAL VIEWS

VII. MANAGING ACCESS TO IMAGES USING ROLES

VIII. MANAGING ACCESS TO WORKFLOWS USING ROLES
A. Access Levels
B. Workflow Levels

IX. IMPLEMENTATION MECHANISMS

### I. Overview

An approach is provided for acquiring and managing images. According to the approach, a reference image of one or more objects is displayed on the display of a mobile device in a manner that allows a user of the mobile device to simultaneously view the reference image and a preview image of the one or more objects currently in a field of view of a camera of the mobile device. For example, the reference image may be displayed on the display of the mobile device at a different brightness level, color, or with special effects, relative to the preview image. An indication is provided to the user of the mobile device whether the camera of the mobile device is currently located within a specified amount of a distance at which the reference image was acquired. For example, a visual or audible indication may indicate whether the camera of the mobile device is too close, too far away, or within a specified amount of a distance at which the reference image was acquired. In response to a user request to acquire an image, the camera acquires a second image of the one or more objects and a distance between the camera and the one or more objects at the time the second image was acquired is recorded. The second image and metadata are transmitted to an image management application that is external to the mobile device. For example, the second image and metadata may be transmitted over one or more networks to the image management application executing on an application server. The image management application provides various functionalities for managing images. For example, the image management application may allow a user to review and accept images, reject images and update metadata for images. As another example, the image management application provides a historical view that allows a user to view a sequence of images of one or more objects that were acquired at approximately the same distance and angle, which allows a user to better discern changes over time in the one or more objects.

According to one embodiment, access to images, workflows and workflow levels is managed using roles. Users are assigned roles and users are permitted to access images, workflows and workflow levels for which they have been assigned the required roles.

### II. System Architecture

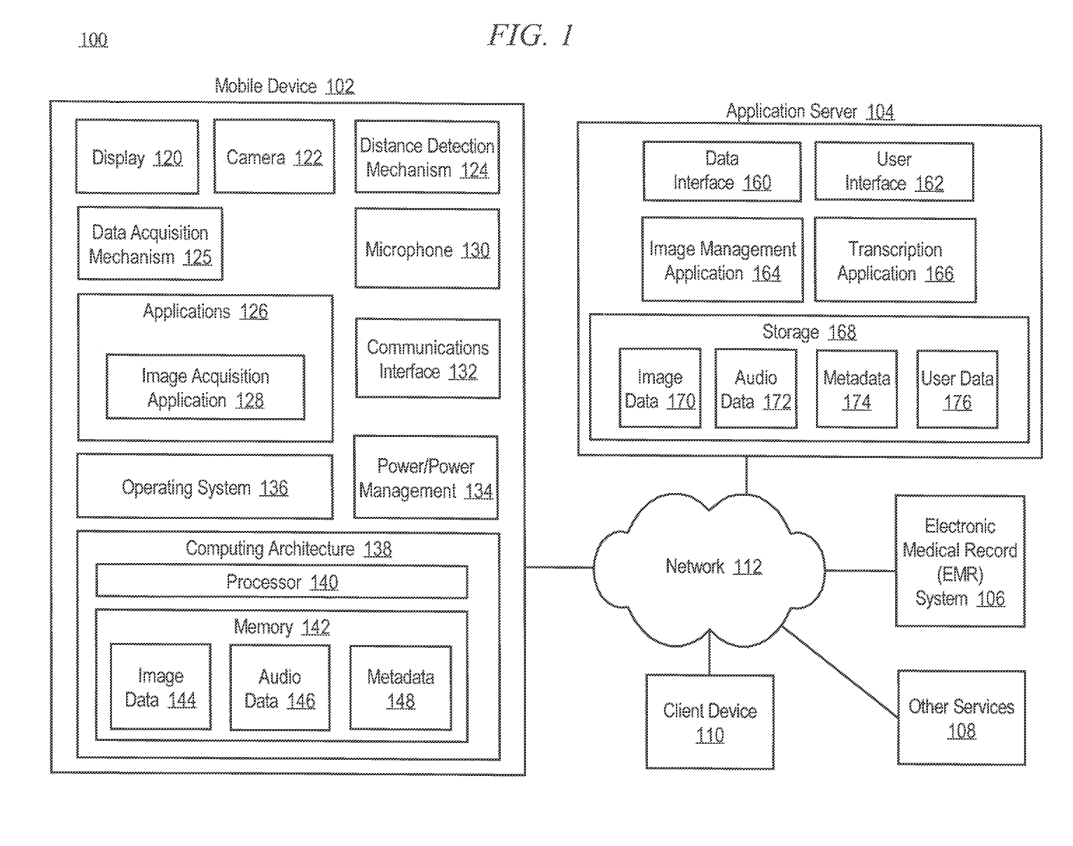

FIG. 1 is a block diagram that depicts an arrangement 100 for acquiring and managing images. Arrangement 100 includes a mobile device 102, an application server 104, an electronic medical record (EMR) system 106, other services 108 and a client device 110, communicatively coupled via a network 112. Arrangement 100 is not limited the particular elements depicted in FIG. 1 and may include fewer or additional elements depending upon a particular implementation. Embodiments are described herein in the context of a single mobile device 102 for purposes of explanation, but the approach is applicable to any number of mobile devices. Network 112 is depicted in FIG. 1 as a single network for purposes of explanation only and network 112 may include any number and type of wired or wireless networks, such as local area networks (LANs), wide area networks (WANs), the Internet, etc. The various elements depicted in FIG. 1 may also communicated with each other via direct communications links.

A. Mobile Device

Mobile device 102 may be any type of mobile device and examples of mobile device 102 include, without limitation, a smart phone, a camera, a tablet computing device, a personal digital assistant or a laptop computer. In the example depicted in FIG. 1, mobile device 102 includes a display 120, a camera 122, a distance detection mechanism 124, a data acquisition component 125, applications 126, including an image acquisition application 128, a microphone 130, a communications interface 132, a power/power management component 134, an operating system 136 and a computing architecture 138 that includes a processor 140 and memory 142, storing image data 144, audio data 146 and metadata 148. Mobile device 102 may include various other components that may vary depending upon a particular implementation and mobile device 102 is not limited to a particular set of components or features. For example, mobile device 102 may include a location component, such as one or more GPS components that is capable of determining a current location of mobile device 102 and generating location data that indicates the current location of mobile device 102. Mobile device 102 may also include manual controls, such as buttons, slides, etc., not depicted in FIG. 1, for performing various functions on mobile device, such as powering on/off or changing the state of mobile device 102 and/or display 120, or for acquiring digital images.

Display 120 may be implemented by any type of display that displays images and information to a user and may also be able to receive user input and embodiments are not limited to any particular implementation of display 120. Mobile device 102 may have any number of displays 120, of similar or varying types, located anywhere on mobile device 102. Camera 122 may be any type of camera and the type of camera may vary depending upon a particular implementation. As with display 120, mobile device 102 may be configured with any number of cameras 122 of similar or varying types, for example, on a front and rear surface of mobile device 102, but embodiments are not limited to any number or type of camera 122.

Distance detection mechanism 124 is configured to detect a distance between the camera 122 on mobile device 102 and one or more objects within the field of view of the camera 122. Example implementations of distance detection mechanism may be based upon, without limitation, infra-red, laser, radar, or other technologies that use electromagnetic radiation. Distance may be determined directly using the distance detection mechanism 124, or distance may be determined from image data. For example, the distance from the camera 122 to one or more objects on the ground and in the field of view of the camera 122 may be calculated based upon a height of the camera 122 and a current angle of the camera 122 with respect to the ground. For example, given a height (h) of the camera 122 and an acute angle (a) between the vertical and a line of sight to the one or more objects, the distance (d) may be calculated as follows: d=h*tan (a). As another example, if one or more dimensions of the one or more objects are known, the distance between the camera 122 and the one or more objects may be determined based upon a pixel analysis of the one or more objects for which the one or more dimensions are known.

Data acquisition component 125 may comprise hardware subcomponents, programmable subcomponents, or both. For example, data acquisition component 125 may include one or more cameras, scanners, memory units or other data storage units, buffers and code instructions for acquiring, storing and transmitting data, or any combination thereof. Data acquisition component 125 may be configured with a Wi-Fi interface and a barcode reader. The Wi-Fi interface may be used to transmit information to and from the data acquisition component 125. The barcode reader may be used to scan or otherwise acquire a code, such as a point of sale (POS) code displayed on an item.

Microphone 130 is configured to detect audio and in combination with other elements, may store audio data that represents audio detected by microphone 130. Communications interface 132 may include computer hardware, software, or any combination of computer hardware and software to provide wired and/or wireless communications links between mobile device 102 and other devices and/or networks. The particular components for communications interface 132 may vary depending upon a particular implementation and embodiments are not limited to any particular implementation of communications interface 132. Power/power management component 134 may include any number of components that provide and manage power for mobile device 102. For example, power/power management component 134 may include one or more batteries and supporting computer hardware and/or software to provide and manage power for mobile device 102.

Computing architecture 138 may include various elements that may vary depending upon a particular implementation and mobile device 102 is not limited to any particular computing architecture 138. In the example depicted in FIG. 1, computing architecture includes a processor 108 and a memory 142. Processor 108 may be any number and types of processors and memory 142 may be any number and types of memories, including volatile memory and non-volatile memory, which may vary depending upon a particular implementation. Computing architecture 138 may include additional hardware, firmware and software elements that may vary depending upon a particular implementation. In the example depicted in FIG. 1 memory 142 stores image data 144, audio data 146 and metadata 148, as described in more detail hereinafter, but memory 142 may store additional data depending upon a particular implementation.

Operating system 136 executes on computing architecture 138 and may be any type of operating system that may vary depending upon a particular implementation and embodiments are not limited to any particular implementation of operating system 136. Operating system 136 may include multiple operating systems of varying types, depending upon a particular implementation. Applications 126 may be any number and types of applications that execute on computing architecture 138 and operating system 136. Applications 126 may access components in mobile device 102, such as display 120, camera 122, distance detection mechanism 124, computing architecture 138, microphone 130, communications interface 132, power/power management component 134 and other components not depicted in FIG. 1, via one or more application program interfaces (APIs) for operating system 136.

Applications 126 may provide various functionalities that may vary depending upon a particular application and embodiments are not limited to applications 126 providing any particular functionality. Common non-limiting examples of applications 126 include social media applications, navigation applications, telephony, email and messaging applications, and Web service applications. In the example depicted in FIG. 1, applications 126 include an image acquisition application 128 that provides various functionalities for acquiring images. Example functionality includes allowing a user to acquire images via camera 122 while a reference image is displayed as a background image. In this example, the image acquisition application 128 is also configured to provide an indication to a user, e.g., a visual or audible indication, to indicate whether the camera 122 of the mobile device 102 is too close, too far away, or within a specified amount of a distance at which the reference image was acquired. Other example functionality includes acquiring metadata, memorandum data and/or audio data that corresponds to the acquired images, and transmitting this information with the acquired images to an image management application that is external to the mobile device 102. These and other example functionalities of image acquisition application 128 are described in more detail hereinafter. Image acquisition application 128 may be implemented in computer hardware, computer software, or any combination of computer hardware and software.

B. Application Server

In the example depicted in FIG. 1, application server 104 includes a data interface 160, a user interface 162, an image management application 164, a transcription application 166 and storage 168 that includes image data 170, audio data 172 and metadata 174. Application server 104 may include various other components that may vary depending upon a particular implementation and application server 104 is not limited to a particular set of components or features. Application server 104 may include various hardware and software components that may vary depending upon a particular implementation and application server 104 is not limited to any particular hardware and software components.

Data interface 160 is configured to receive data from mobile device 102 and may do so using various communication protocols and from various media. Example protocols include, without limitation, the File Transfer Protocol (FTP), the Telnet Protocol, the Transmission Control Protocol (TCP), the TCP/Internet Protocol (TCP/IP), the Hypertext Transfer Protocol (HTTP), the Simple Mail Transfer Protocol (SMTP), or any other data communications protocol. Data receiver 118 may be configured to read data from an FTP folder, an email folder, a Web server, a remote media such as a memory stick, or any other media. Data interface 160 may include corresponding elements to support these transport methods. For example, data interface 160 may include, or interact with, an FTP server that processes requests from an FTP client on mobile device 102. As another example, data interface 160 may include, or interact with, an email client for retrieving emails from an email server on mobile device 102 or external to mobile device 102. As yet another example, data interface 160 may include, or interact with, a Web server that responds to requests from an http client on mobile device 102. Data interface 160 is further configured to support the transmission of data from application server 104 to other devices and processes, for example, EMR system 106, other services 108 and client device 110.

User interface 160 provides a mechanism for a user, such as an administrator, to access application server 104 and data stored on storage 168, as described in more detail hereinafter. User interface 160 may be implemented as an API for application server 104. Alternatively, user interface 160 may be implemented by other mechanisms. For example, user interface 160 may be implemented as a Web server that serves Web pages to provide a user interface for application server 104.

Image management application 164 provides functionality for managing images received from mobile device 102 and stored in storage 168. Example functionality includes reviewing images, accepting images, rejecting images, processing images, for example to improve blurriness or otherwise enhance the quality of images, crop or rotate images, etc., as well as update metadata for images. Example functionality also includes providing a historical view of a sequence of images of one or more objects, where the images in the sequence were acquired using a reference image as a background image and at approximately the same distance from the one or more objects. According to one embodiment, image management application 164 provides a graphical user interface to allow user access to the aforementioned functionality. The graphical user interface may be provided by application software on client device 110, application software on application server 104, or any combination of application software on client device 110 and application server 104. As one example, the graphical user interface may be implemented by one or more Web pages generated on application server 104 and provided to client device 110. Image management application 164 may be implemented in computer hardware, computer software, or any combination of computer hardware and software. For example, image management application 164 may be implemented as an application, e.g., a Web application, executing on application server 104.

Transcription application 166 processes audio data acquired by mobile device 102 and generates a textual transcription. The textual transcription may be represented by data in any format that may vary depending upon a particular implementation. Storage 168 may include any type of storage, such as volatile memory and/or non-volatile memory. Application server 104 is configured to provide image and/or video data and identification data to EMR system 106, other services 108 and client device 110. Application server 104 transmits the data to EMR system 106, other services 108 and client device 110 using standard techniques or alternatively, Application server 104 may transmit data to EMR system 106, other services 108 and client device 110 in accordance with Application Program Interfaces (APIs) supported by EMR system 106, other services 108 and client device 110. Application server 104 may be implemented as a stand-alone network element, such as a server or intermediary device. Application server 104 may also be implemented on a client device, including mobile device 102.

### III. Acquiring Images Using a Reference Image and Distance

According to one embodiment, mobile device 102 is configured to acquire image data using a reference image as a background image and a distance at which the reference image was acquired.

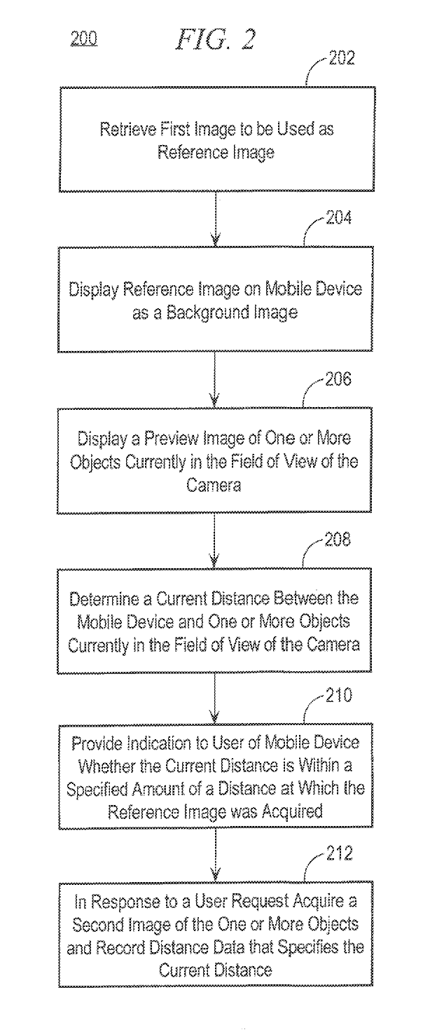

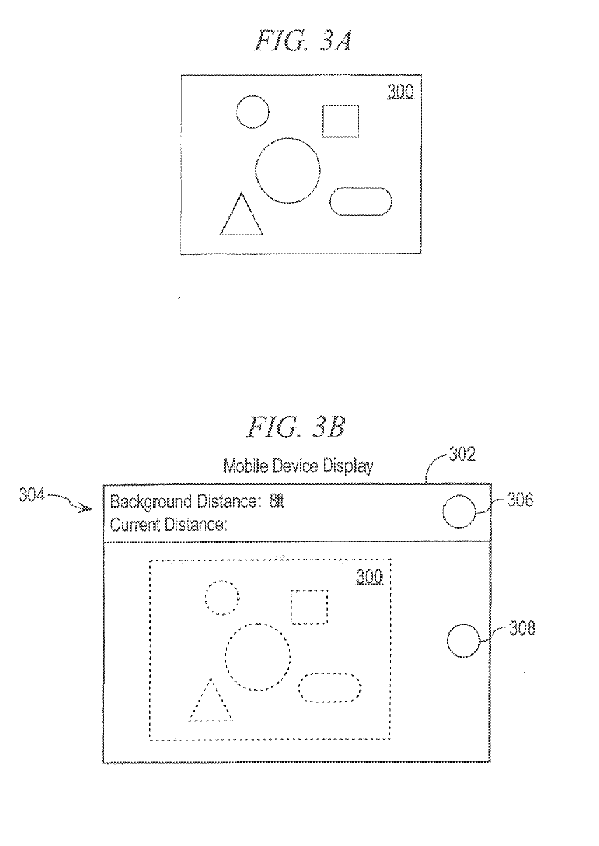

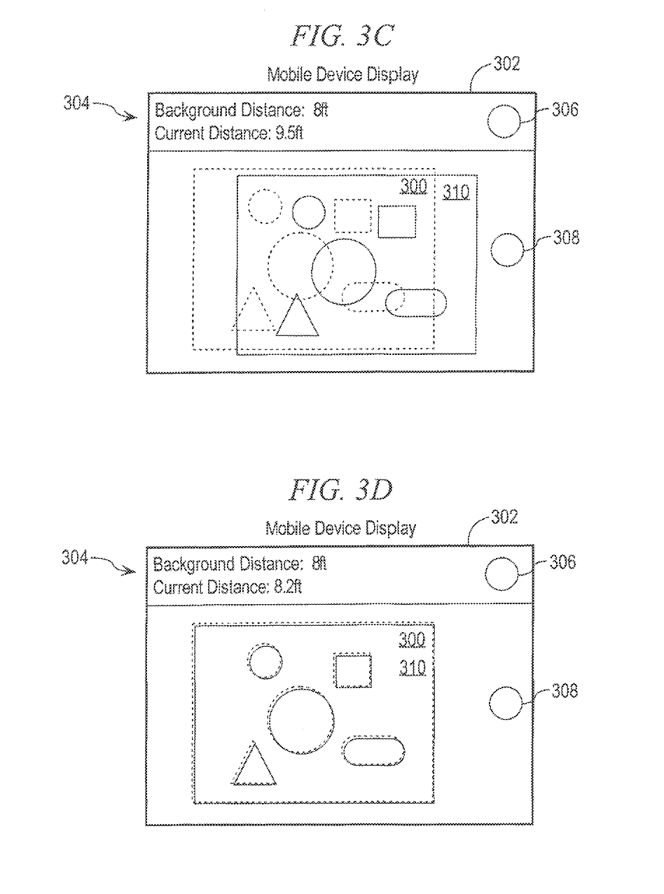

FIG. 2 is a flow diagram 200 that depicts an approach for a mobile device to acquire images using a reference image as a background image and a distance at which the reference image was acquired, according to an embodiment. In step 202, a reference image to be used as a reference image is retrieved. The reference image may be retrieved in response to a user invoking the image acquisition application 128 and specifying an image to be used as the reference image. For example, a user may select an icon on display 120 that corresponds to the image acquisition application 128 to invoke the image acquisition application 128 and the user is then queried for an image to be used as a reference image. The user may then select an image to be used as the reference image, or specify a location, e.g., a path, of an image to be used as the reference image. The reference image may originate and be retrieved from any source. For example, the reference image may have been acquired by mobile device 102 via camera 122 and be stored as image data 144 in memory 142, or at a location external to mobile device 102. As another example, the reference image may have been acquired by a device external to mobile device, such as client device 110, a scanner, or other services 108. The reference image data may be any type or format of image data. Example image data formats include, without limitation, raster formats such as JPEG, Exif, TIFF, RAW, GIF, BMP, PNG, PPM, PGM, PBM, PNM, etc., and vector formats such as CGM, SVG, etc. The reference image may have corresponding metadata 148 that describes one or more attributes of the reference image. Example attributes include, without limitation, camera settings used to acquire the reference image, and a distance from the camera used to acquire the reference image to the one or more objects in the reference image. FIG. 3A depicts an example reference image 300 that includes one or more objects that are represented by different shapes.

In step 204, the reference image is displayed on the mobile device as a background image. For example, image acquisition application 128 may cause the reference image to be displayed on display 120 of mobile device 102. FIG. 3B depicts an example mobile device display 302 that may be, for example, display 120 of mobile device 102. In this example, the reference image 300, which includes the one or more objects, is displayed on the mobile device display 302 as a background image in a manner that allows a user of the mobile device to simultaneously view a preview image of the one or more objects currently in a field of view of the camera. This may be accomplished using a wide variety of techniques that may vary depending upon a particular implementation and embodiments are not limited to any particular technique for displaying the reference image as a background image. For example, one or more attribute values for the reference image 300 may be changed. The attribute values may correspond to one or more attributes that affect the way in which the reference image appears on the mobile device display to a user. Example attributes include, without limitation, brightness, color or special effects. The reference image 300 may be displayed on mobile device display 302 using a lower brightness or intensity than would normally be used to display images on mobile device display 302. As another example, the reference image 300 may be displayed using a different color, shading, outline, or any other visual effect that visually identifies the reference image 300 to a user as a background image.

According to one embodiment, a distance at which the reference image was acquired is indicated on the display of the mobile device. For example, as depicted in FIG. 3B, the distance at which the reference image was acquired may be displayed on the mobile device display 302 by “Background distance: 8 ft”, as indicated by reference numeral 304. In this example, the “Current Distance” is the current distance between the mobile device 102 and the one or more objects currently in the field of view of the camera and viewable by a user as a preview image, as described in more detail hereinafter. The background distance and/or the current distance may be indicated by other means that may vary depending upon a particular implementation, and embodiments are not limited to any particular means for indicating the background distance and the current distance. For example, the background distance and current distance may be indicated by symbols, colors, shading and other visual effects on mobile device display 302.

In step 206, one or more preview images are displayed of one or more objects currently in the field of view of the camera. For example, image acquisition application 128 may cause one or more preview images to be acquired and displayed on display 120. In FIG. 3C, a preview image 310 is displayed on the mobile device display 302. Embodiments are described herein in the context of displaying a single preview image 310 for purposes of explanation only and multiple preview images may be displayed, as described in more detail hereafter. According to one embodiment, the preview image 310 is displayed in a manner to be visually discernable by a user from the reference image 300 displayed as a background image. For example, the preview image 310 may be displayed on the mobile device display 302 using normal intensity, brightness, color, shading, outline, other special effects, etc. Displaying the preview image 310 simultaneously with the reference image 300 displayed as a background image allows a user to visually discern any differences between the distance, height and angle at which the reference image was acquired and the distance, height and angle of the preview image currently displayed on the mobile device display 302. For example, differences in distance may be readily discerned from differences in sizes of the one or more objects, represented in FIG. 3C by the triangle, rectangle, oval and circles in both the reference image 300 and the preview image 310. Differences in angle may be readily discerned when the one or more objects in the reference image 300 and the preview image 310 are three dimensional objects. This allows a user to move and/or orient the mobile device 102 so that the one or more objects depicted in the preview image 310 overlap, or are aligned with, the one or more objects depicted in the reference image 300. Furthermore, successive preview images 310 may be displayed on mobile device display 302, for example on a continuous basis, to allow a user to move and/or reorient the mobile device 102 so that the distance, height and angle of the one or more objects in the reference image 300 and the one or more preview images 310 are at least substantially the same. For example, as depicted in FIG. 3D, the mobile device 102 has been positioned and oriented so that the one or more objects in the reference image 300 and the one or more preview images overlap, indicating that the distance, height and angle of the one or more objects in the reference image 300 and the one or more preview images 310 are at least substantially the same.

In step 208, a determination is made of a current distance between the mobile device and the one or more objects currently in the field of view of the camera. For example, image acquisition application 128 may cause the distance detection mechanism to measure a current distance between the mobile device 102 and the one or more objects in the field of view of the camera 122. As another example, a current distance between the mobile device 102 and the one or more objects in the field of view of the camera 122 may be determined using a GPS component in mobile device 102 and a known location of the one or more objects. In this example, the GPS coordinates of the mobile device 102 may be compared to the GPS coordinates of the one or more objects to determine the current distance between the mobile device 102 and the one or more objects in the field of view of the camera 122.

In step 210, an indication is provided to a user of the mobile device whether the current distance is within a specified amount of the distance at which the reference image was acquired. For example, the image acquisition application 128 may compare the current distance between the mobile device 102 and the one or more objects, as determined in step 208, to the distance at which the reference image was acquired. The result of this comparison may be indicated to a user of the mobile device 102 in a wide variety of ways that may vary depending upon a particular implementation and embodiments are not limited to any particular manner of notification. For example, the image acquisition application 128 may visually indicate on the display 120 whether the current distance is within a specified amount of the distance at which the reference image was acquired. This may include, for example, displaying one or more icons on display 120 and/or changing one or more visual attributes of icons displayed on display 120. As one example, icon 306 may be displayed in red when the current distance is not within the specified amount of the distance at which the reference image was acquired, displayed in yellow when the current distance is close to being within the specified amount of the distance at which the reference image was acquired and displayed in green when the current distance is within the specified amount of the distance at which the reference image was acquired. As another example, an icon, such as a circle may be displayed and the diameter reduced as the current distance approaches the specified amount of the distance at which the reference image was acquired. The diameter of the circle may increase as the difference between the current distance and distance at which the reference image was acquired increases, indicating that the mobile device 102 is getting farther away from the distance at which the reference image was acquired. As another example, different icons or symbols may be displayed to indicate whether the current distance is within the specified amount of the distance at which the reference image was acquired. As one example, a rectangle may be displayed when the mobile device 102 is beyond a specified distance from the distance at which the reference image was acquired and then changed to a circle as the mobile device 102 approaches the distance at which the reference image was acquired.

Image acquisition application 128 may audibly indicate whether the current distance is within a specified amount of the distance at which the reference image was acquired, for example, by generating different sounds. As one example, the mobile device 102 may generate a sequence of sounds, and the amount of time between each sound is decreased as the mobile device approaches the distance at which the reference image was acquired. The current distance between the mobile device 102 and the one or more objects in the field of view of the camera 122 may also be displayed on the display, for example, as depicted in FIGS. 3C and 3D. In this example, the current distance has changed from 9.5 ft to 8.2 ft as the user moved and/or reoriented the mobile device 102, to be closer to the 8.0 ft at which the reference image was acquired.

In step 212, a second image of the one or more objects is acquired in response to a user request. For example, in response to a user selection of a button 308, the second image of the one or more objects that are currently in the field of view is acquired. Metadata is also generated for the second image and may specify, for example, camera parameter values used to acquire the second image, and a timestamp or other data, such as a sequence identifier, that indicates a sequence in which images were acquired. According to one embodiment, the metadata for the second image includes a reference to the reference image so that the reference image and the second image can be displayed together, as described in more detail hereinafter. The reference may be in any form and may vary depending upon a particular implementation. For example, the reference may include the name or identifier of the reference image. The metadata for the reference image may also be updated to include a reference to the second image.

According to one embodiment, camera settings values used to acquire the reference image are also used to acquire the second image. This ensures, for example, that the same camera settings, such as focus, aperture, exposure time, etc., are used to acquire both the reference image and the second image. This reduces the likelihood that differences in the one or more objects in the sequence of images are attributable to different camera settings used to acquire the images, rather than actual changes in the one or more objects. Camera settings used to acquire an image may be stored in the metadata for the acquired image, for example, in metadata 148, 174.

The current distance may optionally be reacquired and recorded in association with the second image, for example, in the metadata for the second image. Alternatively, the distance at which the reference image was acquired may be used for the second image, since the current distance is within the specified amount of the distance at which the reference image was acquired.

Image data, representing the second image, and optionally the current distance, may be stored locally on mobile device, for example, in memory 142, and/or may be transmitted by mobile device 102 for storage and/or processing on one or more of application server 104, EMR system 106, other services 108 or client device 110. Image data may be transmitted to application server 104, EMR system 106, other services 108 or client device 110 using a wide variety of techniques, for example, via FTP, via email, via http POST commands, or other approaches. The transmission of image data, and the corresponding metadata, may involve the verification of credentials. For example, a user may be queried for credential information that is verified before image data may be transmitted to application server 104, EMR system 106, other services 108 or client device 110. Although the foregoing example is depicted in FIG. 2 and described in the context of acquiring a second image, embodiments are not limited to acquiring a single image using a reference image and any number of subsequent images may be acquired using a reference image as a background image. When more than one subsequent images are acquired using a reference image, the metadata for the subsequent images may include a reference to the reference image and the other subsequent images that were acquired using the reference image. For example, suppose that a second and third image were acquired using the reference image. The metadata for the second image may include a reference to the reference image and to the third image. The metadata for the third image may include a reference to the reference image and the second image. The metadata for the reference image may include no references the second and third images, a reference to the second image, a reference to the third image, or both. The reference data and timestamp data are used to display the reference image and one or more subsequent images acquired using the reference image as a background image as an ordered sequence, as described in more detail hereinafter.

### IV. Memo and Audio Data

According to one embodiment, memorandum (memo) and/or audio data may be acquired to supplement image data. Memorandum data may be automatically acquired by data acquisition component 125, for example, by scanning encoded data associated with the one or more objects in the acquired image. For example, a user of mobile device 102 may scan a bar code or QR code attached to or otherwise associated with the one or more objects, or by scanning a bar code or QR code associated with a patient, e.g., via a patient bracelet or a patient identification card. Memorandum data may be manually specified by a user of mobile device 102, for example, by selecting from one or more specified options, e.g., via pull-down menus or lists, or by entering alphanumeric characters and/or character strings.

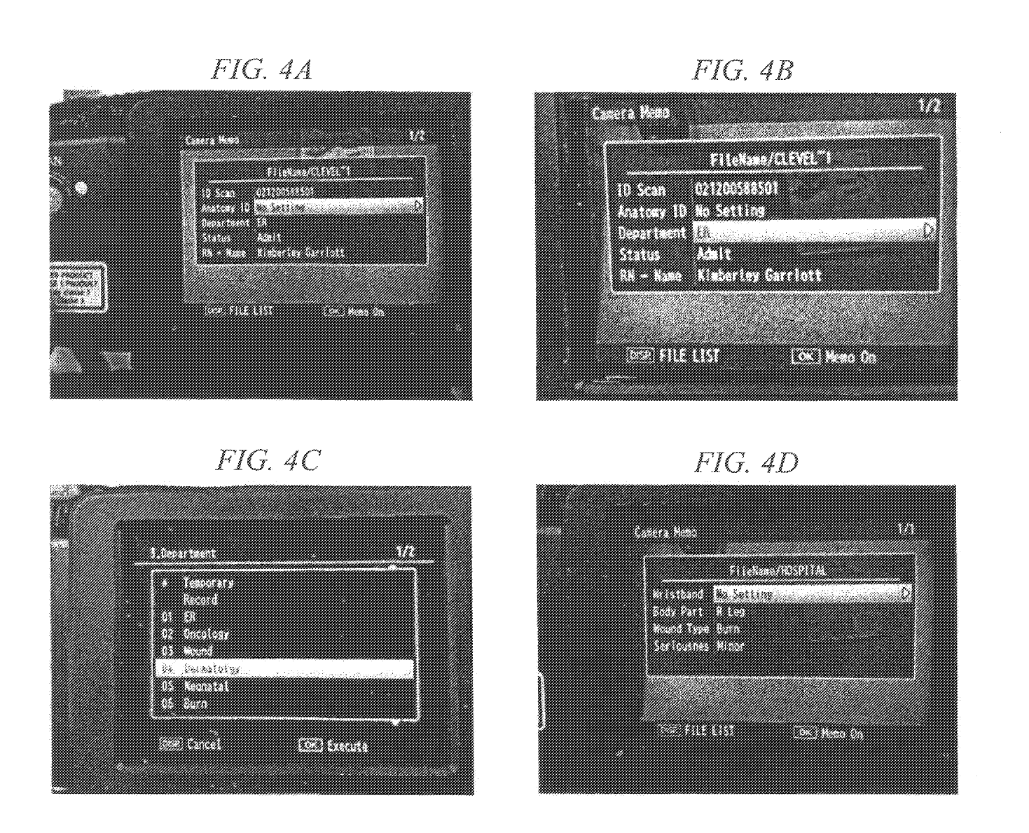

FIGS. 4A-D depict an example graphical user interface displayed on display 120 of mobile device 102 that allows a user to specify memorandum data in a medical context. The graphical user interface may be generated, for example, by image acquisition application 128. FIG. 4A depicts top-level information that includes a patient identification field (“ID Scan”), an anatomy identification field (“Anatomy ID”), a department field (“Department”), a status field (“Status”) and a registered nurse name (“RN—Name”). FIG. 4B depicts that a user has used one or more controls (graphical or physical) on mobile device 102 to navigate to the department field. FIG. 4C depicts the department options available to the user after selecting the department field and that the user has navigated to the Dermatology department option. In FIG. 4D, the graphical user interface allows the user to specify a wristband setting, a body part, a wound type and an indication of the seriousness of the injury.

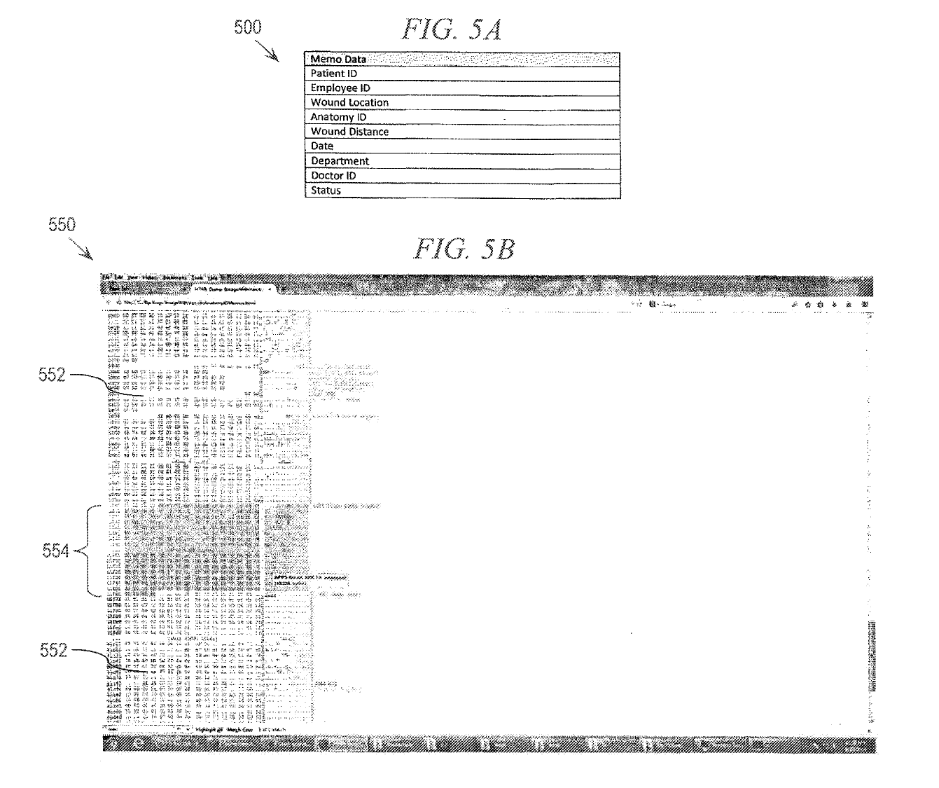

FIG. 5A depicts a table 500 of example types of memorandum data. Although embodiments are described in the context of example types of memorandum data for purposes of explanation, embodiments are not limited to any particular types of memorandum data. In the example table 500 depicted in FIG. 5A, the memorandum data is in the context of images of a human wound site and includes a patient ID, an employee ID, a wound location, an anatomy ID, a wound distance, i.e., a distance between the camera 122 and the wound site, a date, a department, a doctor ID and a status.

Audio data may be acquired, for example, by image acquisition application 128 invoking functionality provided by operating system 136 and/or other applications 126 and microphone 130. The acquisition of audio data may be initiated by user selection of a graphical user interface control or other control on mobile device 102. For example, a user may initiate the acquisition of audio data at or around the time of acquiring one or more images to supplement the one or more images. As described in more detail hereinafter, audio data may be processed by transcription application 166 to provide an alphanumeric representation of the audio data.

Memorandum data and/or audio data may be stored locally on mobile device, for example, in memory 142, and/or may be transmitted by mobile device 102 for storage and/or processing on one or more of application server 104, EMR system 106, other services 108 or client device 110. Memorandum data may be stored as part of metadata 148, 174. Audio data may be stored locally on mobile device 102 as audio data 146 and on application server 104 as audio data 172. In addition, memorandum data and/or audio data may be transmitted separate from or with image data, e.g., as an attachment, embedded, etc.

FIG. 5B is a table 550 that depicts a textual representation of image data 552 that includes embedded audio data 554. In this example, audio data 146, 172 is stored as part of image data 144, 170. Memorandum data may similarly be embedded in image data. The way in which memorandum data and audio data is stored may vary from image data to image data and not all memorandum data and audio data must be stored in the same manner. For example, audio data that corresponds to a reference image may be embedded in the image data for the reference image, while audio data that corresponds to a second image may be stored separate from the image data for the second image.

### V. Image Data Management

Various approaches are provided for managing image data. According to one embodiment, image management application 164 provides a user interface for managing image data. The user interface may be implemented, for example, as a Web-based user interface. In this example, a client device, such as client device 110, accesses image management application 164 and the user interface is implemented by one or more Web pages provided by image management application 164 to client device 110.

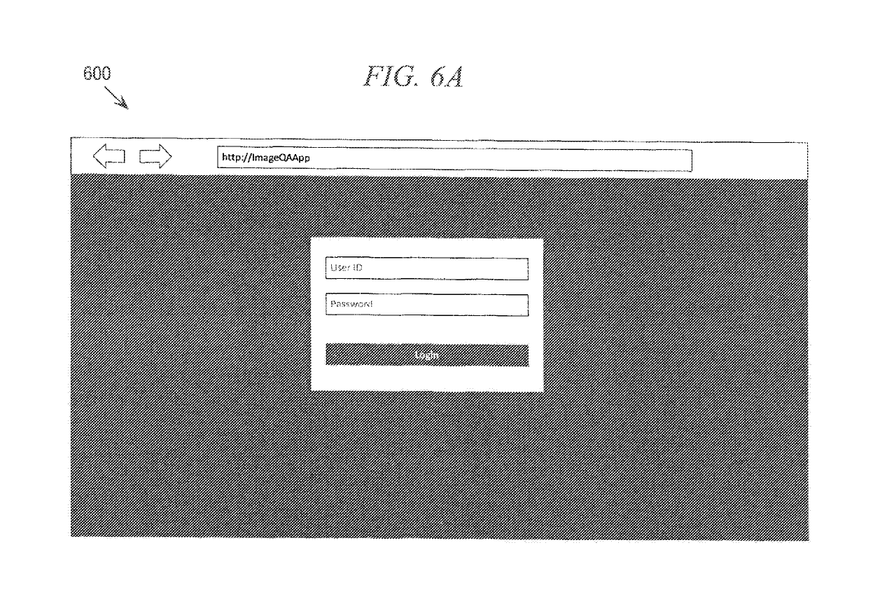

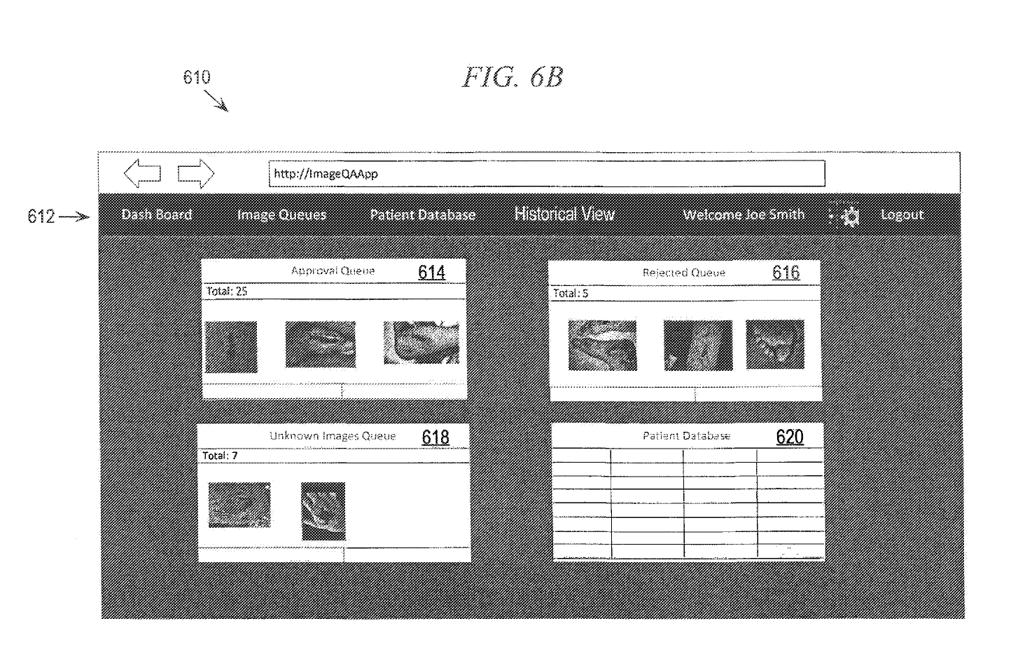

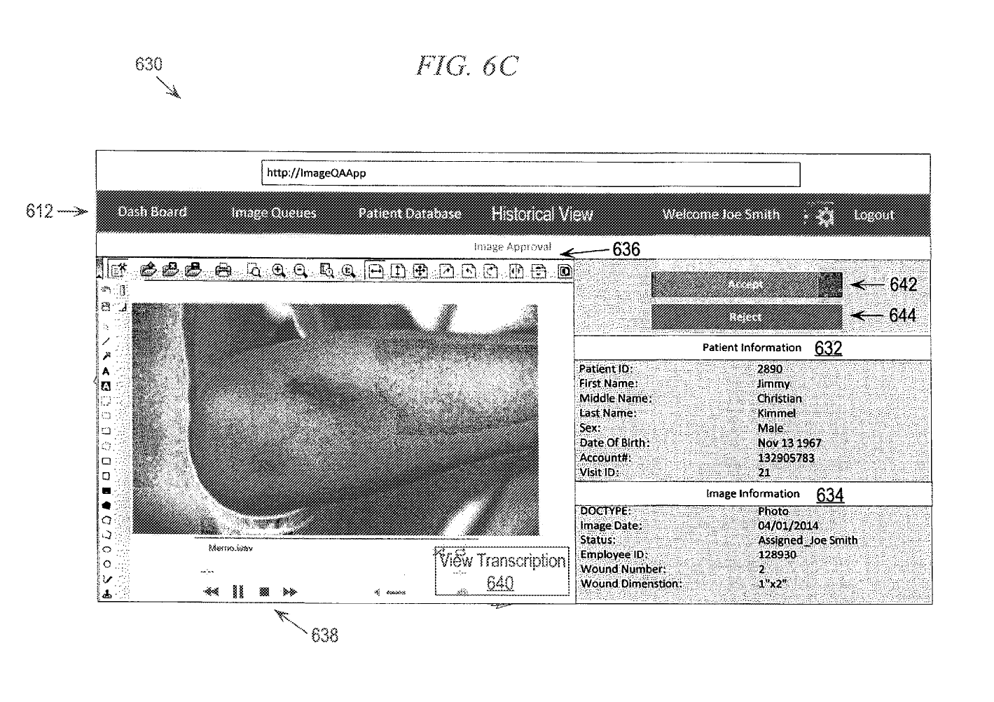

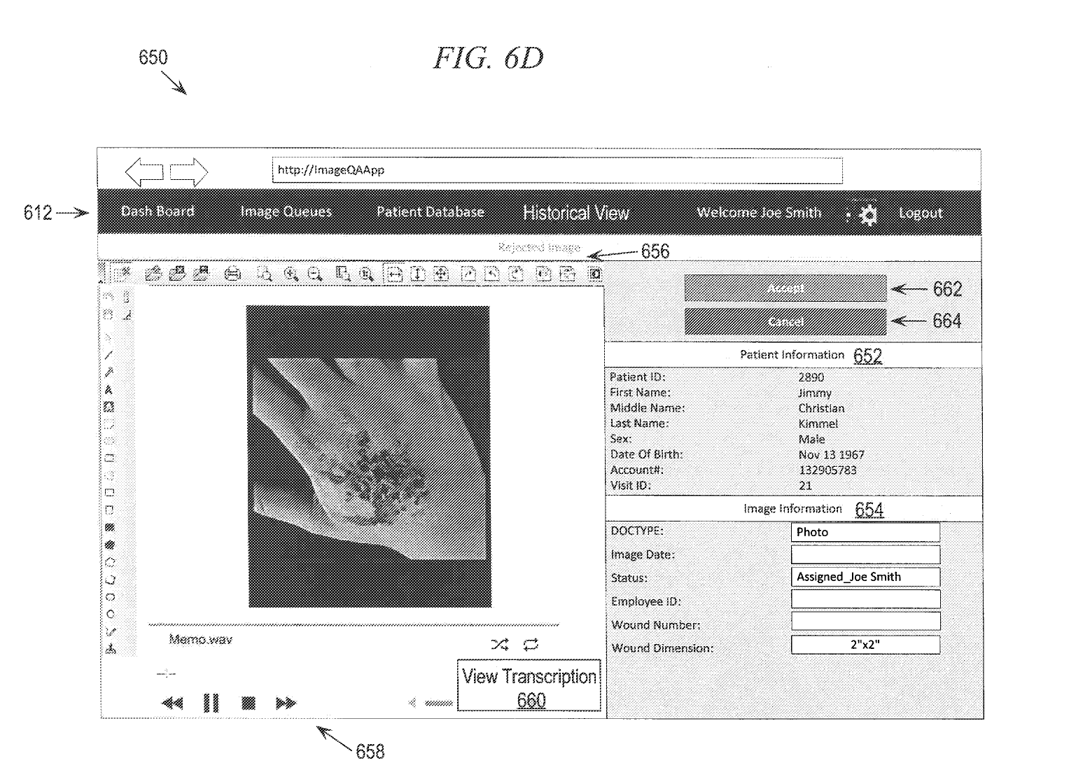

FIGS. 6A-6D depict an example graphical user interface for managing image data according to an embodiment. The example graphical user interface depicted in FIGS. 6A-6D may be provided by one or more Web pages generated on application server 104 and provided to client device 110. FIG. 6A depicts an example login screen 600 that queries a user for user credentials that include a user login ID and password.

FIG. 6B depicts an example main screen 610, referred to hereinafter as a “dashboard 610”, that provides access to various functionality for managing image data. In the example depicted in FIG. 6B, the dashboard 610 provides access, via graphical user interface controls 612, to logical collections of images referred to hereinafter as “queues,” a user database in the form of a patient database and historical views of images. Although embodiments are described hereinafter in the medical/accident context for purposes of explanation, embodiments are not limited to this context. The queues include an Approval Queue, a Rejected Queue and an Unknown Images Queue that may be accessed via graphical user interface icons 614, 616, 618, respectively. The patient database may be accessed via graphical user interface icon 620.

FIG. 6C depicts an example Approval Queue screen 630, or work queue, that allows a user to view and approve or reject images. Approval Queue screen 630 displays patient information 632 of a patient that corresponds to the displayed image and image information 634 for the displayed image. Approval Queue screen 630 includes controls 636 for managing the displayed image, for example, by expanding (horizontally or vertically) or rotating the displayed image. Controls 638 allow a user to play an audio recording that corresponds to the displayed image. Control 640 allows a user to view an alphanumeric transcription of the audio recording that corresponds to the displayed image. The alphanumeric transcription may be generated by transcription application 166 and displayed to a user in response to a user selection of control 640. Approval Queue screen 630 also includes controls 642, 644 for approving (accepting) or rejecting, respectively, the displayed image. A displayed image might be rejected for a wide variety of reasons that may vary depending upon a particular situation. For example, a user might choose to reject a displayed image because the image is out of focus, the image is otherwise of poor quality, the image does not show the area of interest, or the information associated with the image, such as the patient information 632 or the image information 634 is incomplete.

FIG. 6D depicts an example Rejected Image Processing screen 650 that allows a user to view and update information for rejected images. Rejected Image Processing screen 650 displays patient information 652 of a patient that corresponds to the displayed image and image information 654 for the displayed image. A user may correct or add to the meta data or memorandum data for the displayed image. For example, the user may correct or add to the patient information 652 or the image information 654, e.g., by selecting on a field and manually entering alphanumeric information. Rejected Image Processing screen 650 includes controls 656 for managing the displayed image, for example, by expanding (horizontally or vertically) or rotating the displayed image. Controls 658 allow a user to play an audio recording that corresponds to the displayed image. Control 660 allows a user to view an alphanumeric transcription of the audio recording that corresponds to the displayed image. Rejected Image Processing screen 650 also includes controls 662, 664 for approving (accepting) or rejecting, respectively, the displayed image. For example, after making changes to the displayed image, the patient information 652 or the image information 654, a user may select control 662 to accept the displayed image and cause the displayed image to be added to the Approval queue. Alternatively, a user may maintain the displayed image as rejected by selecting control 664 to cancel.

The unknown images queue accessed via control 618 includes images for which there are incomplete information or other problems, which may occur for a variety of reasons. For example, a particular image may have insufficient metadata to associate the particular image with other images. As another example, a particular image may be determined to not satisfy specified quality criteria, such as sharpness, brightness, etc. Users may perform processing on images in the unknown images queue to provide incomplete information and/or address problems with the images. For example, a user may edit the metadata for a particular image in the unknown images queue to supply missing data for the particular image. As another example, a user may process images in the unknown image queue to address quality issues, such as poor focus, insufficient brightness or color contrast, etc. The images may then be approved and moved to the approval queue or rejected and moved to the rejected queue.

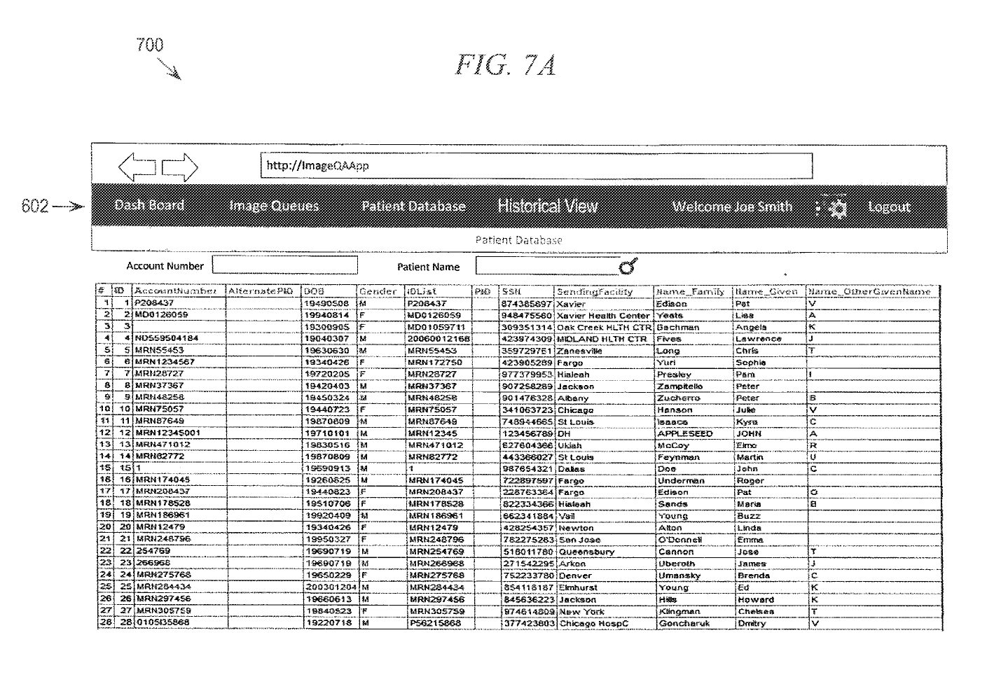

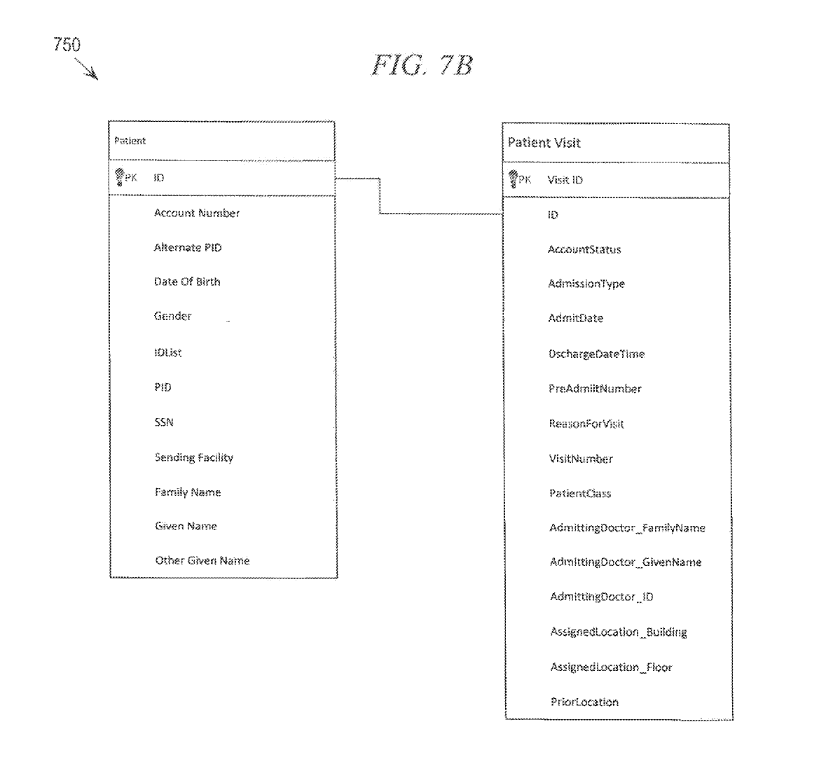

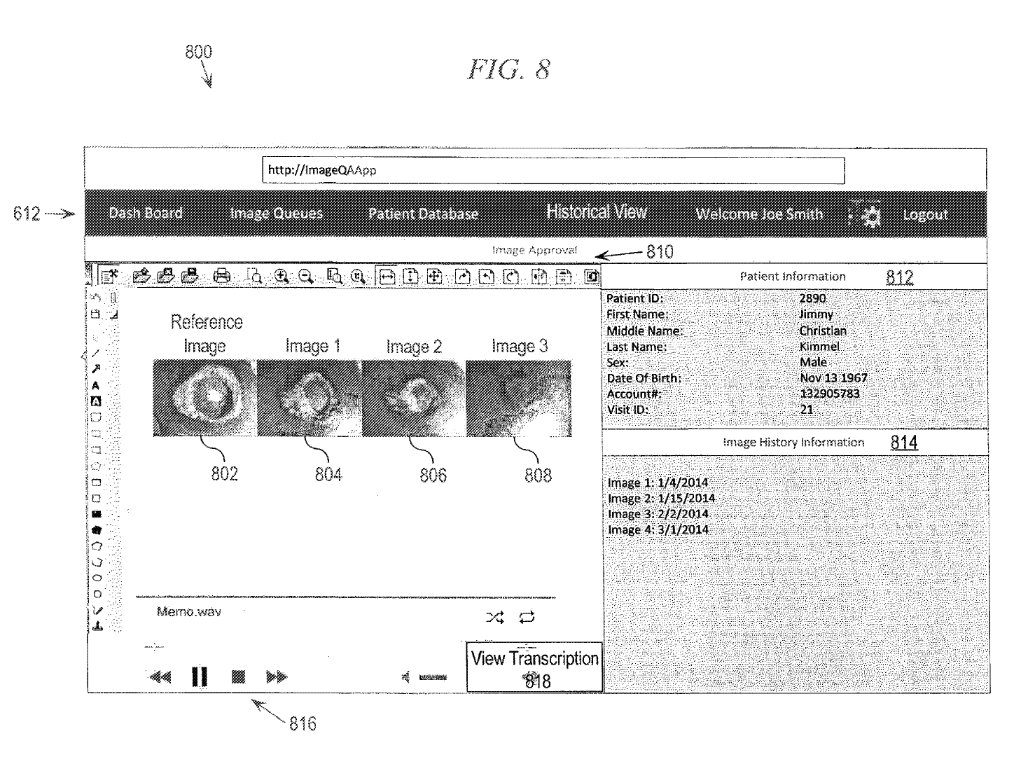

FIG. 7A is a table 700 that depicts an example patient database, where each row of the table 700 corresponds to a patient and specifies an identifier, a date of birth (DOB), a gender, an ID list, a social security number (SSN), a sending facility, a family name, a first (given) name and another given (middle) name. Table 700 may be displayed in response to a user selecting the “Patient Database” control 612. FIG. 7B is a table 750 that depicts an example patient database schema.

### VI. Historical Views

According to one embodiment, images are displayed to a user using a historical view. In general, a historical view displays a sequence of images that includes a reference image and one or more other images acquired using the reference image as a background image as described herein.

FIG. 8 depicts an example historical view screen 800 generated by image management application 164 according to an embodiment. A user of client device 110 may access image management application 164 and request access to a historical view of images, for example, by selecting the “Historical View” control 612. In response to this request, image management application 164 may provide access to historical view screen 800. As one non-limiting example, historical view screen 800 may be represented by one or more Web pages provided by image management application 164 to client device 110.

In the example depicted in FIG. 8, historical view screen 800 includes a plurality of graphical user interface objects that include graphical user interface controls 612 that provide access to the dashboard, the image queues and the patient database previously described herein. The historical view screen 800 includes a sequence of images 802-808 of one or more objects selected by a user. When the historical view screen 800 is first displayed, a user may be shown a collection of image sequences, where each image sequence is represented by one or more graphical user interface objects, such as an icon, textual description, thumbnail image or other information. The user selects a graphical user interface object, for example an icon, which corresponds to a particular image sequence of interest, and the images in the particular sequence are displayed.

One or more graphical user interface controls may be provided to arrange the image sequences by a time of information selected, e.g., user identification, organization, event, subject, date/time, etc. The graphical user interface controls may also allow a user to enter particular criteria and have the image sequences that correspond to the particular criteria be displayed. In the example depicted in FIG. 8, the images 802-808 correspond to a particular patient identified in patient information 812. Each image sequence includes the reference image and one or more subsequent images acquired using the reference image, as previously described herein. Note that in the example depicted in FIG. 8, multiple image sequences may be provided for a single user, i.e., a single patient. For example, suppose that a patient sustained injuries on two locations of their body, e.g., an arm and a leg. In this example, one image sequence may correspond to the patient's arm and another image sequence may correspond to the patient's leg.

The images 802-808 include a reference image 802 and three subsequent images acquired using the reference image 802, namely, Image 1 804, Image 2 806 and Image 3 808. In this example, Image 1 804, Image 2 806 and Image 3 808 were acquired using the reference image 802 displayed on the mobile device 102 as a background image, as previously described herein. In addition, the images 802-808 are arranged on historical view screen 800 in chronological order, based upon the timestamp or other associated metadata, starting with the reference image 802, followed by Image 1 804, Image 2 806 and Image 3 808.

Historical view screen 800 also includes controls 810 for managing displayed images 802-808 and information about a user that corresponds to the images 802-808, which in the present example is represented by patient information 812. Image history information 814 displays metadata for images 802-808. In the example depicted in FIG. 8, the metadata includes a date at which each image 802-808 was acquired, but the metadata may include other data about images 802-808, for example, a distance at which the images were acquired 802-808, timestamps, memorandum data, etc. Metadata may also be displayed near or on a displayed image. For example, the timestamp that corresponds to each image 802-808 may be superimposed on, or be displayed adjacent to, each image 802-808.

Controls 816 allow a user to play an audio recording that corresponds to the displayed image and a control 818 allows a user to view an alphanumeric transcription of the audio recording that corresponds to the displayed image.

The historical view approach for displaying a sequence of images that includes a reference image and one or more other images that were acquired using the reference image as a background image and at approximately the same distance is very beneficial to see changes over time in the one or more objects captured in the images. For example, the approach allows medical personnel to view changes over time of a wound or surgical sight. As another example, the approach allows construction personnel to monitor progress of a project, or identify potential problems, such as cracks, improper curing of concrete, etc. As yet another example, the approach allows a user to monitor changes in natural settings, for example, to detect beach or ground erosion.

### VII. Managing Access to Images Using Roles

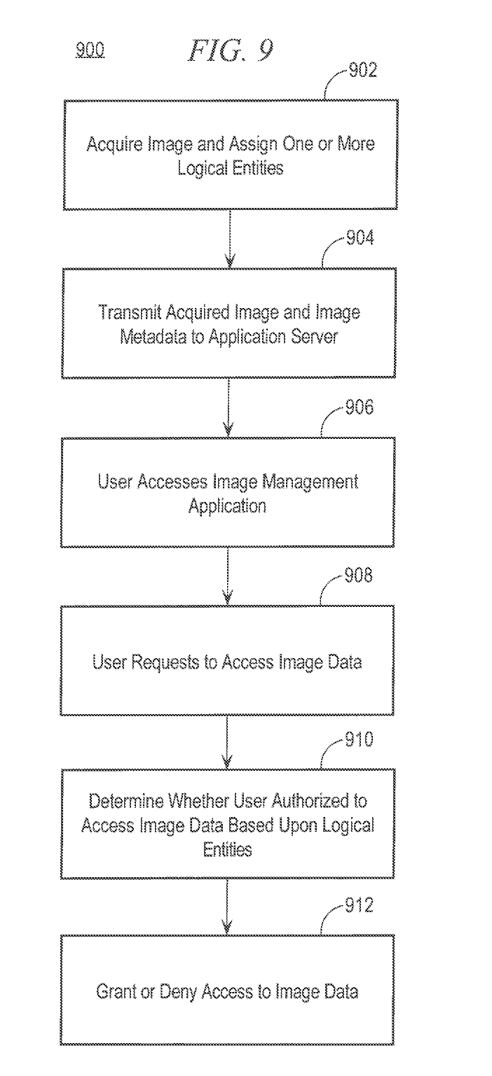

According to one embodiment, access to images acquired using mobile devices is managed using roles. Images acquired by a mobile device are assigned one or more logical entities. Users are also assigned one or more roles. The term “role” is used herein to refer to a logical entity and users may have any number of roles. As described in more detail hereinafter, a role for a user may specify one or more logical entities assigned to the user, as well as additional information for the user, such as one or more workflows assigned to the user. Users are allowed to access image data for which they have been assigned the required logical entities. The approach provides a flexible and extensible system for managing access to image data and is particularly beneficial in situations when images contain sensitive information. The approach may be used to satisfy business organization policies/procedure and legal and regulatory requirements. The approaches described herein are applicable to any type of logical entities. Examples of logical entities include, without limitation, a business organization, a division, department, group or team of a business organization. FIG. 9 is a flow diagram 900 that depicts an approach for managing access to images using logical entities. The approach of FIG. 9 is described in the context of a single image for purposes of explanation, but the approach is applicable to any number and types of images.

In step 902, an image is acquired by a client device. For example, a user of mobile device 102 may acquire an image using image acquisition application 128 and metadata for the acquired image is generated. As previously described herein, the metadata for the acquired image may specify the camera settings used to acquire the image, as well as memorandum data for the image. According to one embodiment, metadata for the acquired image specifies one or more logical entities assigned to the acquired image. The one or more logical entities may be specified in a wide variety of ways that may vary depending upon a particular implementation. For example, mobile device 102 may be configured to automatically assign one or more particular logical entities to images captured by mobile device 102. This may be useful, for example, when mobile device 102 is associated with a particular logical entity, such as a department of a business organization, so that images captured with the mobile device 102 are automatically assigned to the department of the business organization. Alternatively, logical entities may be specified by a user of the mobile device. For example, a user of mobile device 102 may manually specify one or more logical entities to be assigned to a captured image. This may be accomplished by the user selecting particular logical entities from a list of available logical entities. For example, image acquisition application 128 may provide graphical user interface (GUI) controls for selecting logical entities. As another example, mobile device 102 may include manual controls that can be used to select logical entities. Alternatively, a user may manually enter data, such as the names, IDs, etc., of one or more logical item groups to be assigned to an acquired image. As another example, a user of a mobile device may use the mobile device to scan encoded data to assign one or more logical groups to an acquired image. For example, a user may use data acquisition mechanism 125 of mobile device 102 to scan encoded data that corresponds to one or more logical entities. Logical entities may be assigned to images in a similar manner for other types of image acquisition devices. For example, images acquired by a scanning device, MFP or camera may be assigned logical entities by a user of the scanning device, MFP or camera, e.g., via a graphical user interface or controls provided by the scanning device, MFP or camera.

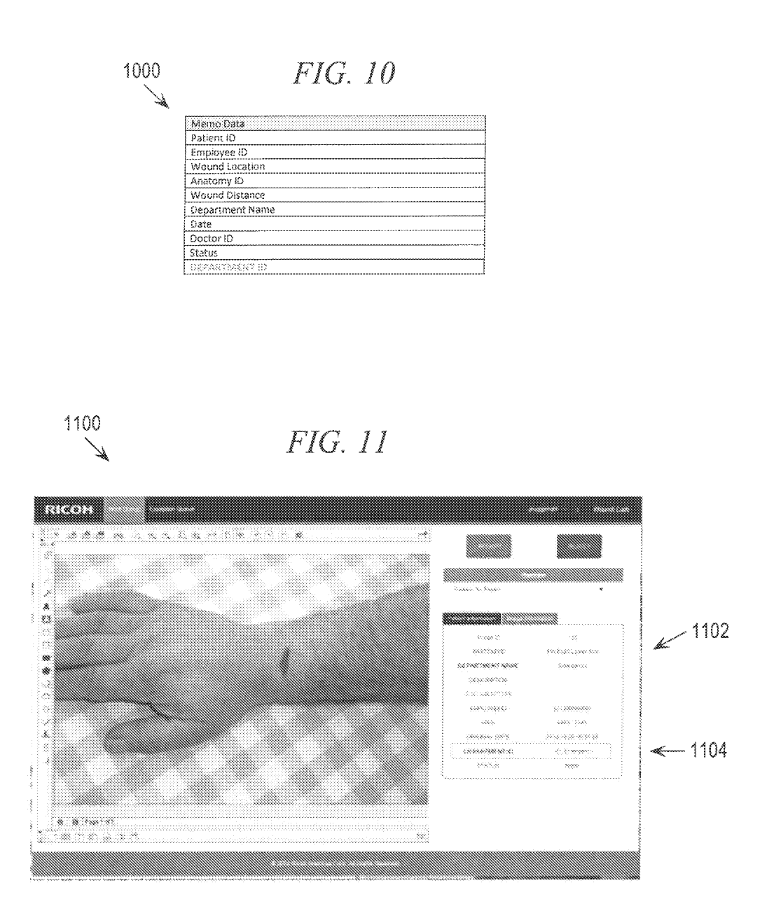

FIG. 10 depicts a table 1000 of example types of memorandum data that may be included in the metadata for an image. Although embodiments are described in the context of example types of memorandum data for purposes of explanation, embodiments are not limited to any particular types of memorandum data. In the example table 1000 depicted in FIG. 10, the memorandum data is in the context of images of a human wound site and includes a patient ID, an employee ID, a wound location, an anatomy ID, a wound distance, i.e., a distance between the camera 122 and the wound site, a date, a department name, a doctor ID, a status, and a logical entity in the form of a department ID. The department ID field of the memorandum data depicted in FIG. 10 may specify any number of departments. For example, the department ID field may specify an emergency room department as “ID_ER” or a pediatrics department as “ID_Pediatrics.”

In step 904, the acquired image and metadata for the acquired image are transmitted to application server 104. For example, image acquisition application 128 on mobile device 102 may cause the acquired image and corresponding metadata to be transmitted to application server 104 and stored in storage 168. The location where the image data and metadata are stored may be automatically configured in mobile device 102 or the location may be specified by a user, for example, by selecting one or more locations via a GUI displayed by image acquisition application 128. Image data and metadata may be immediately transmitted to application server 104 as soon as the image data and metadata are acquired. Alternatively, image data and metadata may be stored locally on mobile device 102 and transmitted to application server 104 when requested by a user. This may allow a user an opportunity to select particular images, and their corresponding metadata, that are to be transmitted to application server 104.

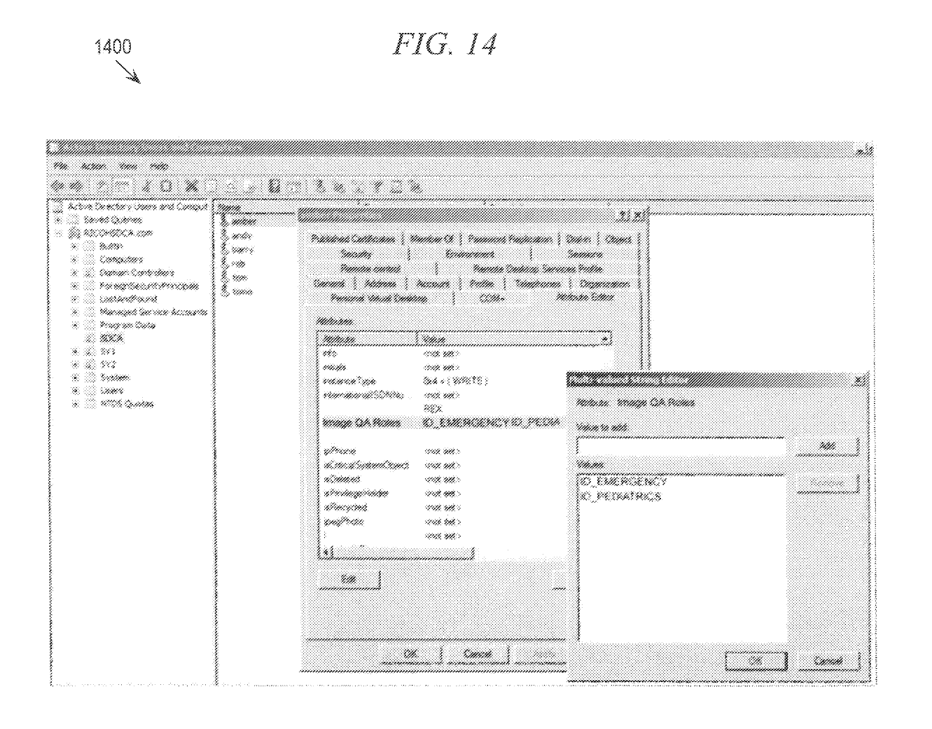

In step 906, a user wishing to view images acquired by mobile device 102 accesses image management application 164. For example, a user of client device 110 accesses image management application 164 on application server 104. The user of client device 110 may be the same user that acquired the images using mobile device 102, or a different user. As previously described herein, users may be required to be authenticated before being allowed to access image management application 164. For example, as depicted later herein with respect to FIG. 14, in the context of a system that implements Active Directory, a user requesting access to image management application 164 may be queried for user credentials and the Active Directory determines, based upon the user credentials, whether the user is a normal user or an administrator. The authentication required to access image management application 164 to specify roles, i.e., logical entities, for users may be different than the authentication required to access EMR system 106.

In step 908, the user requests to access image data. As previously described herein, users may access images in a wide variety of ways, e.g., via dashboard 610 to access logical collections of images, such as Approval Queue, Rejected Queue, Unknown Queue, etc.

In step 910, a determination is made whether the user is authorized to access the requested image data using logical entities. According to one embodiment, this includes determining one or more roles, i.e., logical entities, assigned to the user and determining one or more logical entities assigned to the image data that the user requested to access. The determination whether the user is authorized to access the requested image data is then made based upon the one or more roles, i.e., logical entities, assigned to the user and the one or more logical entities assigned to the image data that the user requested to access. Consider an example in which a particular image has been acquired via mobile device 102 and stored on application server 104, and a particular user wishes to access the particular image. After being authenticated to access image management application 164 and requesting access to the particular image, one or more roles, i.e., logical entities, assigned to the user and one or more logical entities assigned to the particular image are determined. According to one embodiment, if any of the one or one or more roles, i.e., logical entities, assigned to the user match the one or more logical entities assigned to the particular image, then the user is granted access to the particular image. For example, suppose that the particular image has been assigned the logical entities “Emergency Room” and “Pediatrics.” In this example, if the particular user has been assigned either the role, i.e., logical entity, “Emergency Room” or “Pediatrics,” then in step 912, the user is granted access to the particular image. Otherwise, in step 912, the user is not granted access to the particular image.

FIG. 11 depicts an example GUI screen 1100 after a user has been granted access to a requested image. In this example, GUI screen 1100 includes information 1102 about the image. The information 1102 may include data from the metadata for the image, such as memorandum data. The information 1102 includes a logical entity in the form of a Department ID assigned to the image which, in the present example, is “ID_EMERGENCY.” According to one embodiment, the logical entities assigned to images may be changed. For example, image management application 164 may provide an administrative GUI for adding, editing and deleting logical entities assigned to images.

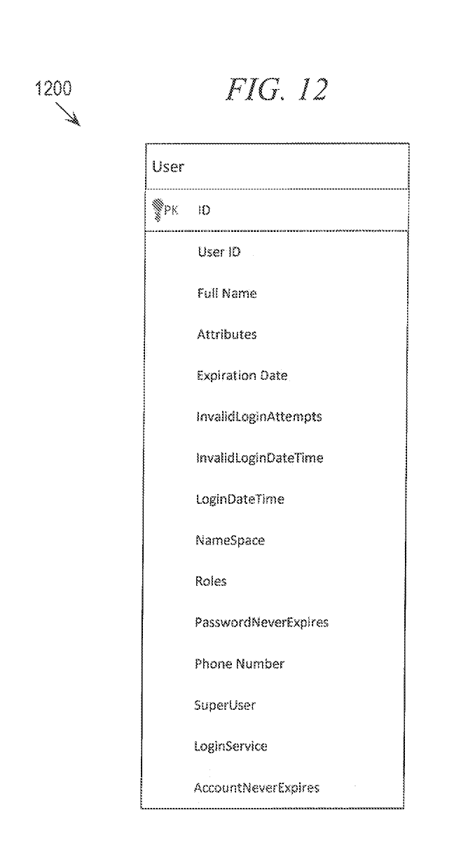

FIG. 12 depicts an example user table schema 1200 that defines an example data schema for users. In this example, the user data includes a user ID, a full name, one or more attributes of the user, an expiration date, invalid login attempts, invalid login dates and times, login dates and times, a namespace, one or more roles, data indicating whether the user's password never expires, a phone number, data indicating whether the user is a super user, a login service and data indicating whether the user's account never expires. As previously described herein, the roles for a user may specify one or more logical entities assigned to the user, as well as additional information, such as one or more workflows. Additional data, or less data, may be included in a user table schema, depending upon a particular implementation, and embodiments are not limited to the data depicted in the example user table schema of FIG. 12.

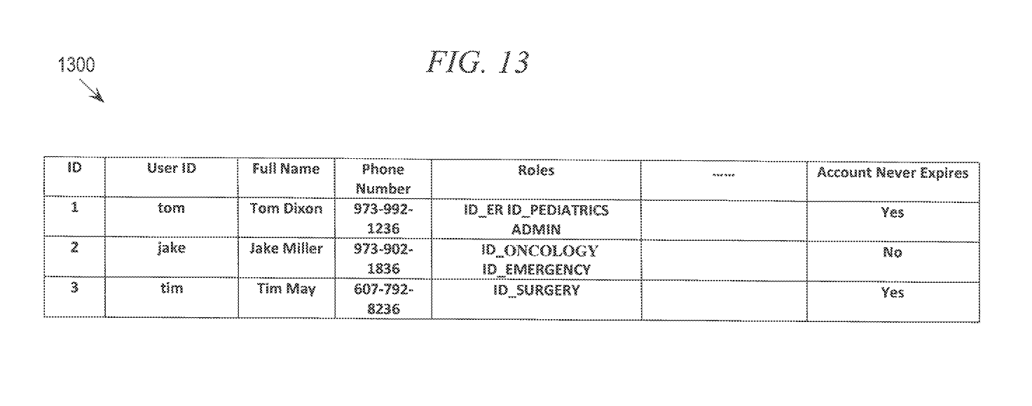

FIG. 13 depicts an example user table 1300 that specifies various types of user data. More specifically, in user table 1300, each row corresponds to a user and each column specifies a value for a data type. The columns may correspond to the data types depicted in the user table schema 1200 of FIG. 12. In the example depicted in FIG. 13, the data types include a user ID, a full name, a phone number, roles, one or more other data types, and whether the account never expires. The full name is the full name of the user, the phone number is the phone number of the user and the account never expires specifies whether the account of the user never expires. The roles specify the roles, i.e., logical entities, assigned to the user. In the example depicted in FIG. 13, the user corresponding to the first row of the user table 1300 has assigned roles of “ID_ER”, “ID_PEDIATRICS” and “ADMIN,” which may correspond to the emergency room and pediatrics departments of a business organization, such as a medical provider. The assigned role of “ADMIN” may permit the user to have administrative privileges with respect to application server 104. This user will therefore be allowed to access images associated with the emergency room and pediatrics departments in the business organization, and is also allowed to perform various administrative functions on application server 104. In contrast, the user corresponding to the third row of the user table 1300 has a single assigned role of “ID_SURGERY,” which may correspond to a surgery department within a business organization, such as a medical provider.

User data may be stored on application server 104, for example, in user data 176 on storage 168. Alternatively, user data may be stored remotely with respect to application server 104 and accessed by image management application 164, for example, via network 112. User data 176 may be managed by image management application 164 and according to one embodiment, image management application 164 provides a user interface that allows users, such as an administrator, to define and update user data. FIG. 14 depicts an example GUI 1400 for specifying user data. In the example depicted in FIG. 14, the GUI 1400 provides a window 1402 that allows a user to specify roles, i.e., logical entities, for a user. In this example, the roles of “ID_EMERGENCY” and “ID_PEDIATRICS” have already been defined for user “amber” and additional roles may be specified.

### VIII. Managing Access to Workflows Using Roles

According to one embodiment, access to workflows to process images acquired using mobile devices is managed using roles. The term “workflow” is used herein to refer to a process for processing images acquired by mobile devices and the processes may be provided, for example, by image management application 164. Example processes include, without limitation, processes for approving, rejecting and updating images, and viewing historical views of images, as described herein. Users are authorized to access particular workflows, as specified by user data. When a particular user requests access to a particular process for processing images acquired by mobile devices, a determination is made, based upon the user data for the user, whether the user is authorized to access the particular process to process images acquired by mobile devices. The user is granted or not granted access based upon the determination.

Further access control may be provided using roles. More specifically, user data and roles may be used to limit access by a user to a particular workflow and particular images. For example, as described in more detail hereinafter, a request for a user to process a particular image using a particular workflow (or a request to access the particular workflow to process the particular image) may be verified based upon both whether the user is authorized to access the particular workflow and whether the user is authorized to access the particular image. In addition, workflow levels may be used to manage access to particular functionality within a workflow. Thus, different levels of access granularity may be provided, depending upon a particular implementation.

A. Access Levels

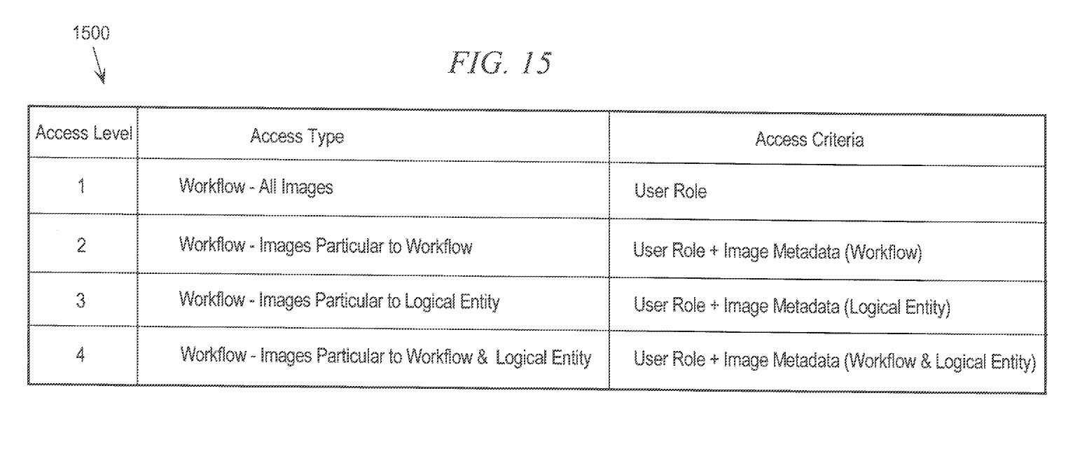

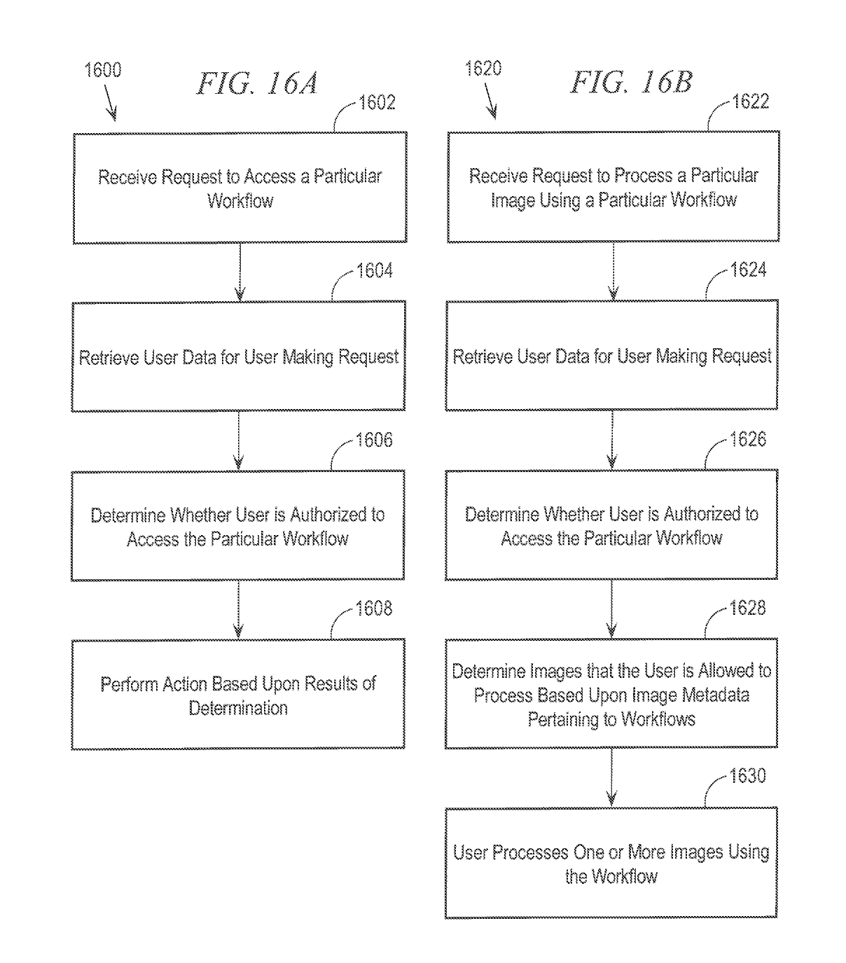

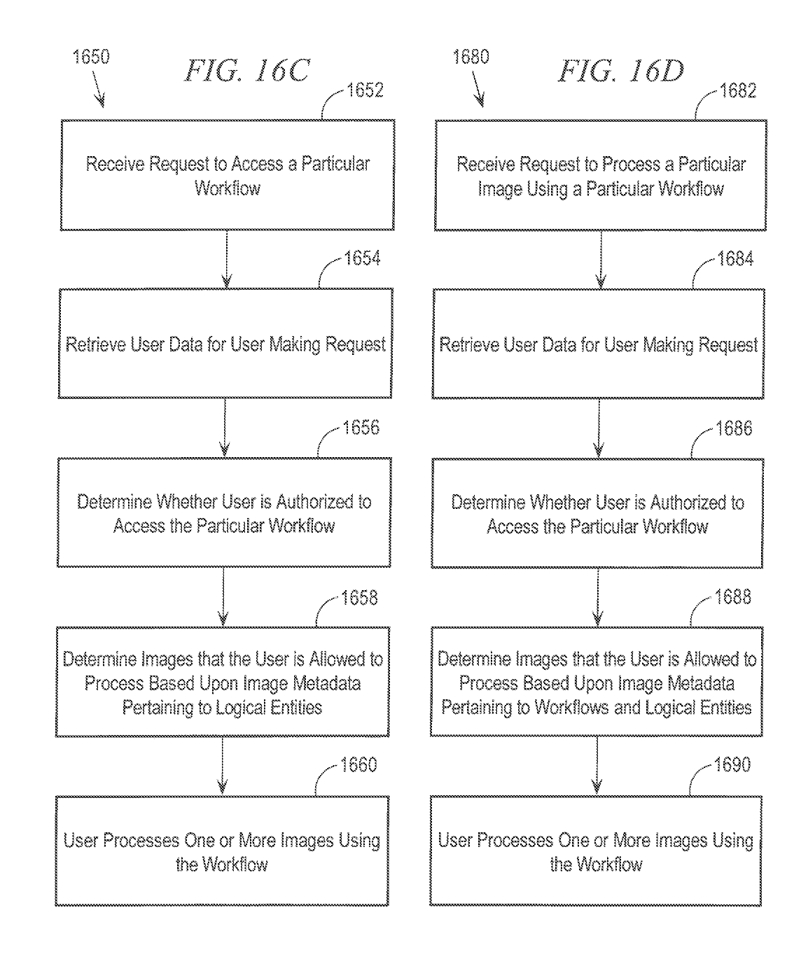

FIG. 15 is a table 1500 that depicts four example levels of access to workflows and images. The example levels of access depicted in FIG. 15 represent a hierarchy of access management, with the level of access control generally increasing from Level 1 to Level 4. In Level 1, a user is granted access to a particular workflow and is able to process any images with the particular workflow. For example, a user may be granted access to a process for viewing and approving or rejecting images, as previously described herein. This example process is used as an example workflow for describing FIG. 15 and FIGS. 16A-16D. For Level 1, the user's role, and more particularly the processes that the user is authorized to access, are used as the access criteria, as indicated by the user data 176 for the user. In this example, the user data 176 for the user must specify that the user is authorized to access the process for viewing and approving or rejecting images.

FIG. 16A is a flow diagram 1600 that depicts an approach for managing access to a workflow using the access criteria for Level 1. In step 1602, a request is received to access a particular workflow, which in the present example is the process for viewing and approving or rejecting images, as previously described herein. For example, a user of client device 110 may access a GUI provided by image management application 164 and request to access the process to view and approve or reject images. In step 1604, user data for the user making the request is retrieved. For example, image management application 164 may retrieve user data 176 for the user requesting to access the process provided by image management application 164 for viewing and approving or rejecting images. In step 1606, a determination is made whether the user is authorized to access the particular workflow, i.e., the process to view and approve or reject images. For example, image management application 164 may determine, based upon the user data 176 for the user, whether the user is authorized to access the process provided by image management application 164 for viewing and approving or rejecting images. The user data 176 for the user may specify by name, ID, etc., one or more processes that the user is authorized to access. In step 1608, one or more actions are performed based upon the results of the determination in step 1606. For example, the user may be granted or denied access to the process provided by image management application 164 for viewing and approving or rejecting images.

In Level 2, a user is granted access to a particular workflow and images that are particular to the workflow. Level 2 differs from Level 1 in that a user is not granted access to all images using the workflow, but only images that are particular to the workflow. For example, a user may be granted access to the process for viewing and approving or rejecting images, but only with respect to images that are particular to the particular workflow. For Level 2, the user's role and image metadata, pertaining to associated workflows, are used as access criteria. More specifically, the user's data must specify that the user is authorized to access the particular workflow and also the metadata for the images must specify that the images are associated with the particular workflow. In this example, the user data 176 for the user must specify that the user is authorized to access the process for viewing and approving or rejecting images and the metadata for the images must specify that the images are associated with the process for viewing and approving or rejecting images. Access is not allowed for images that are not associated with the particular workflow.

FIG. 16B is a flow diagram 1620 that depicts an approach for managing access to a workflow using the access criteria for Level 2. In step 1622, a request is received to access the process for viewing and approving or rejecting images. In step 1624, user data for the user making the request is retrieved and in step 1626, a determination is made whether the user is authorized to access the process to view and approve or reject images, as previously described herein. Assuming that the user is authorized to access the process to view and approve or reject images, then in step 1628, a determination is made of the images that the user is allowed to process using the process to view and approve or reject images. For Level 2, this includes examining image metadata to identify images that are associated with the process to view and approve or reject images. In step 1630, the user processes one or more of the available images using the process provided by image management application 164 for viewing and approving or rejecting images.

In Level 3, a user is granted access to a particular workflow and images that are particular to logical entities that the user is allowed to access. For example, a user may be granted access to a process for viewing and approving or rejecting images, but only with respect to images that are particular to a particular logical entity, such as a department within a business organization, that the user is authorized to access. For Level 3, the user's role and image metadata, pertaining to logical entities, are used as access criteria. More specifically, the user's data must specify that the user is authorized to access the particular workflow and a particular logical entity, e.g., a particular department of a business organization. Also, the metadata for the images must specify that the images are associated with the specified logical entity. In this example, the user data 176 for the user must specify that the user is authorized to access the process for viewing and approving or rejecting images and is authorized to access images for the particular department of the business organization. The metadata for the images must specify that the images are associated with the department within the business organization. Unlike Level 2, the images are not required to be associated with the workflow, i.e., the process for viewing and approving or rejecting images. Access is not allowed, however, for images that are not associated with the particular logical entity, i.e., the department within the business organization, that the user is authorized to access.

FIG. 16C is a flow diagram 1650 that depicts an approach for managing access to a workflow using the access criteria for Level 3. In step 1522, a request is received to access the process for viewing and approving or rejecting images. In step 1654, user data for the user making the request is retrieved and in step 1656, a determination is made whether the user is authorized to access the process to view and approve or reject images, as previously described herein. Assuming that the user is authorized to access the process to view and approve or reject images, then in step 1658, a determination is made of the images that the user is allowed to process using the process to view and approve or reject images. For Level 3, this includes examining the user data for the user to determine one or more logical entities assigned to the user. Image metadata is also examined to identify images that are associated with the one or more logical entities assigned to the user. For example, suppose that the user is assigned to a particular department within a business organization. In this example, the user is allowed to use the particular process to process images that are associated with the particular department within the business organization. Note that the images are not required to be associated with the workflow, i.e., the process for viewing and approving or rejecting images. In step 1630, the user processes one or more of the available images using the process provided by image management application 164 for viewing and approving or rejecting images.

In Level 4, a user is granted access to a particular workflow and images that are particular to both the particular workflow and logical entities that the user is allowed to access. For example, a user may be granted access to the process for viewing and approving or rejecting images, but only with respect to images that are particular to both the process for viewing and approving or rejection images and a logical entity, such as a department within a business organization, that is assigned to the user. For Level 4, the user's role and image metadata pertaining to associated workflows and logical entities are used as access criteria. More specifically, the user's data must specify that the user is authorized to access the particular workflow and one or more logical entities. The metadata for the images must specify that the images are associated with both the particular workflow and the one or more logical entities assigned to the user. Access is not allowed for images that are not associated with both the particular workflow and the one or more logical entities assigned to the user.

FIG. 16D is a flow diagram 1680 that depicts an approach for managing access to a workflow using the access criteria for Level 4. In step 1682, a request is received to access the process for viewing and approving or rejecting images. In step 1684, user data for the user making the request is retrieved and in step 1686, a determination is made whether the user is authorized to access the process to view and approve or reject images, as previously described herein. Assuming that the user is authorized to access the process to view and approve or reject images, then in step 1688, a determination is made of the images that the user is allowed to process using the process to view and approve or reject images. For Level 4, this includes examining the user data for the user to determine one or more logical entities assigned to the user. Image metadata is also examined to identify images that are associated with both the particular workflow, i.e., the process to view and approve or reject images, and the one or more logical entities assigned to the user. In step 1690, the user processes one or more of the available images using the process provided by image management application 164 for viewing and approving or rejecting images.

The foregoing examples are depicted and described in the context of accessing a particular workflow, i.e., a process for processing images acquired by mobile device 102, but embodiments are not limited to these example processes and are applicable to any types of processes. In addition, the approach is applicable to workflows implemented by other processes implemented application server 104 and also remote to application server 104. In this context, image management application 164 may act as a gatekeeper to processes executing remote to image management application 164.

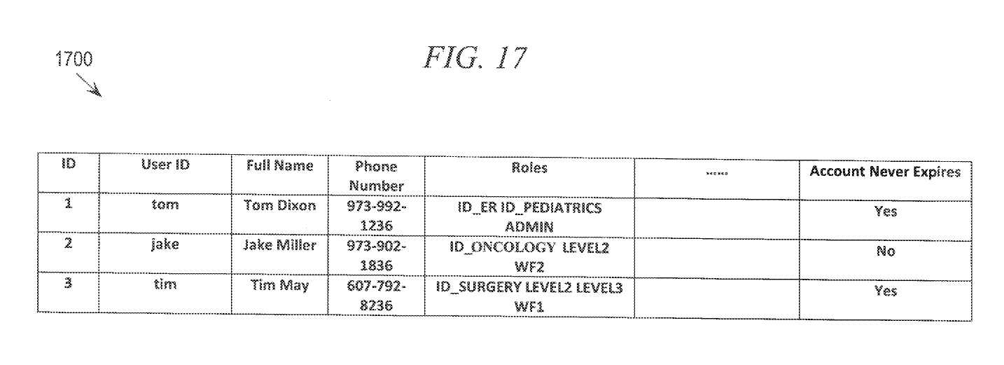

FIG. 17 depicts an example user table 1700 that specifies various types of user data. More specifically, in user table 1700, each row corresponds to a user and each column specifies a value for a data type. The columns may correspond to the data types depicted in the user table schema 1200 of FIG. 12. In the example depicted in FIG. 17, the data types include a user ID, a full name, a phone number, roles, one or more other data types, and whether the account never expires. The full name is the full name of the user, the phone number is the phone number of the user and the account never expires specifies whether the account of the user never expires. The roles specify the roles, i.e., logical entities and workflows, assigned to the user. In the example depicted in FIG. 17, the user corresponding to the first row of the user table 1700 has assigned roles of “ID_ER”, “ID_PEDIATRICS” and “ADMIN,” which may correspond to the emergency room and pediatrics departments of a business organization, such as a medical provider. The assigned role of “ADMIN” may permit the user to have administrative privileges with respect to application server 104. This user will therefore be allowed to access images associated with the emergency room and pediatrics departments in the business organization, and is also allowed to perform various administrative functions on application server 104. In contrast, the user corresponding to the third row of the user table 1300 has a single assigned role of “ID_SURGERY,” which may correspond to a surgery department within a business organization, such as a medical provider. The user corresponding to the first row of the user table 1700 does not have any assigned workflows, but the user corresponding to the second row of user table 1700 is assigned a workflow identified as “WF2” and the user corresponding to the third row of user table 1700 is assigned a workflow identified as “WF1”. In addition, the user data in user table 1700 specifies levels within workflows. Specifically, the user corresponding to the second row of user table 1700 is assigned “Level 2” of the workflow identified as “WF2” and the user corresponding to the third row of user table 1700 is assigned “Level 3” a workflow identified as “WF1”. The use of levels within workflows provides additional granularity with respect to managing access to workflows, as described in more detail hereinafter.

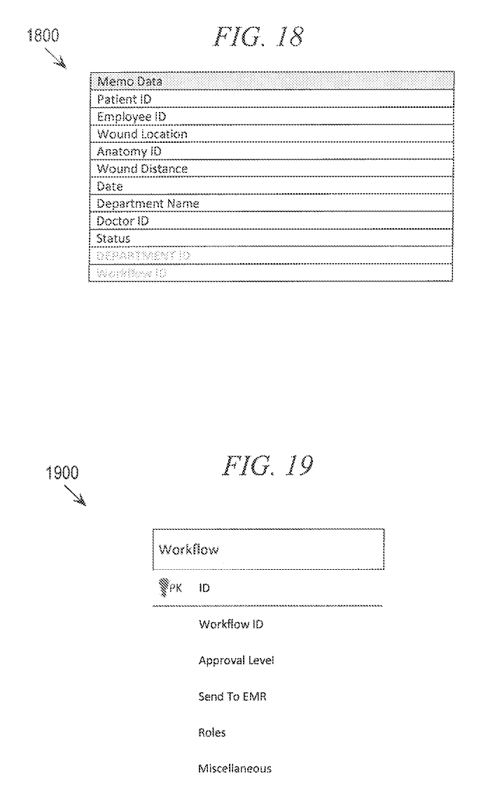

FIG. 18 depicts a table 1800 of example types of memorandum data that may be included in the metadata for an image. Although embodiments are described in the context of example types of memorandum data for purposes of explanation, embodiments are not limited to any particular types of memorandum data. In the example table 1800 depicted in FIG. 18, the memorandum data is in the context of images of a human wound site and includes a patient ID, an employee ID, a wound location, an anatomy ID, a wound distance, i.e., a distance between the camera 122 and the wound site, a date, a department name, a doctor ID, a status, a logical entity in the form of a department ID and a workflow identified by a workflow ID. The department ID field of the memorandum data depicted in FIG. 18 may specify any number of departments. For example, the department ID field may specify an emergency room department as “ID_ER” or a pediatrics department as “ID_Pediatrics.” The workflow ID field of the memorandum data depicted in FIG. 18 may specify any number of workflows. For example, the workflow ID field may specify a first workflow by “WF1” and a second workflow by “WF2”. The workflow ID field may also specify workflow levels, for example, by “Level 3” or “Level 2”.

FIG. 19 depicts an example workflow schema 1900 that defines an example data schema for workflows. In this example, the workflow data includes a workflow ID, an approval level, a send to EMR data value, roles and miscellaneous data values. The workflow ID is data that uniquely identifies a workflow. The approval level is data that indicates a level of approval required to use the workflow. The send to EMR data value indicates whether the results of the workflow should be sent to EMR system 106. The roles data value indicates one or more logical entities assigned to the workflow. For example, a workflow may be assigned to a particular department within a business organization. The miscellaneous data values may be other miscellaneous data associated with a workflow and the particular data values may vary, depending upon a particular implementation.

B. Workflow Levels

According to one embodiment, a workflow may have any number of workflow levels, where each workflow level represents a part of the workflow process. Workflow levels provide additional granularity for managing access to workflows because users may be given selective access to some workflow levels within a workflow, but not other workflow levels in the same workflow. For example, as previously described herein with respect to FIG. 17, user data may define the workflows and workflow levels assigned to particular users and the workflows and/or workflow levels assigned to users may be changed over time, e.g., by an administrator.

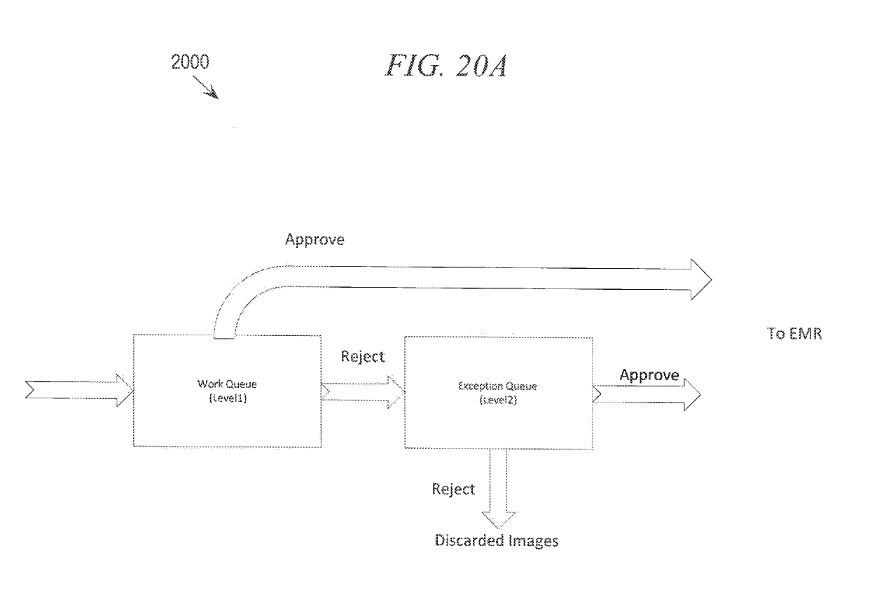

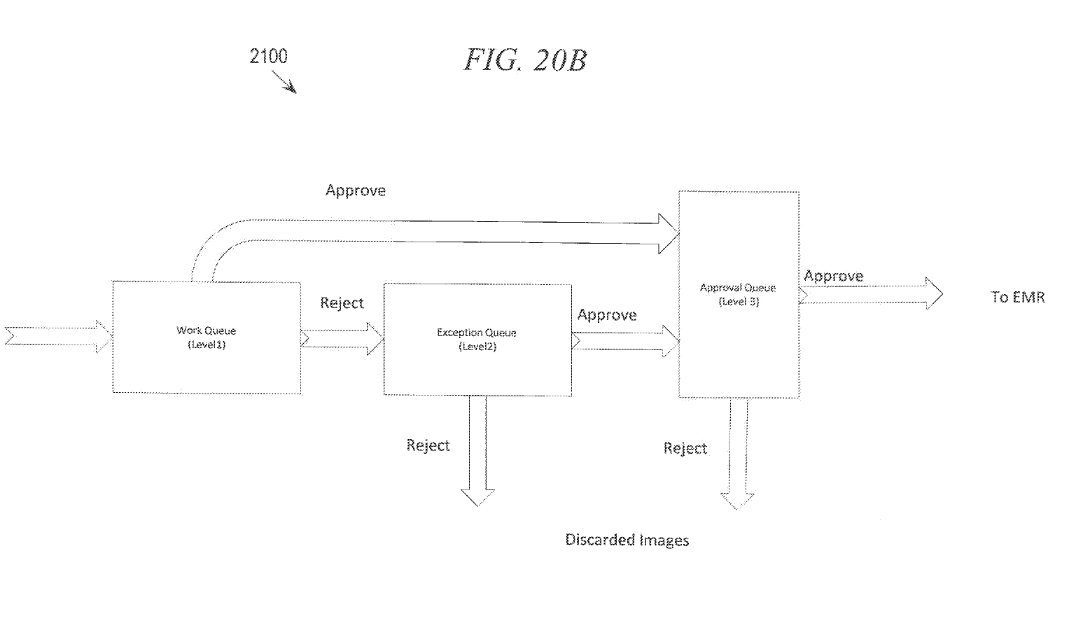

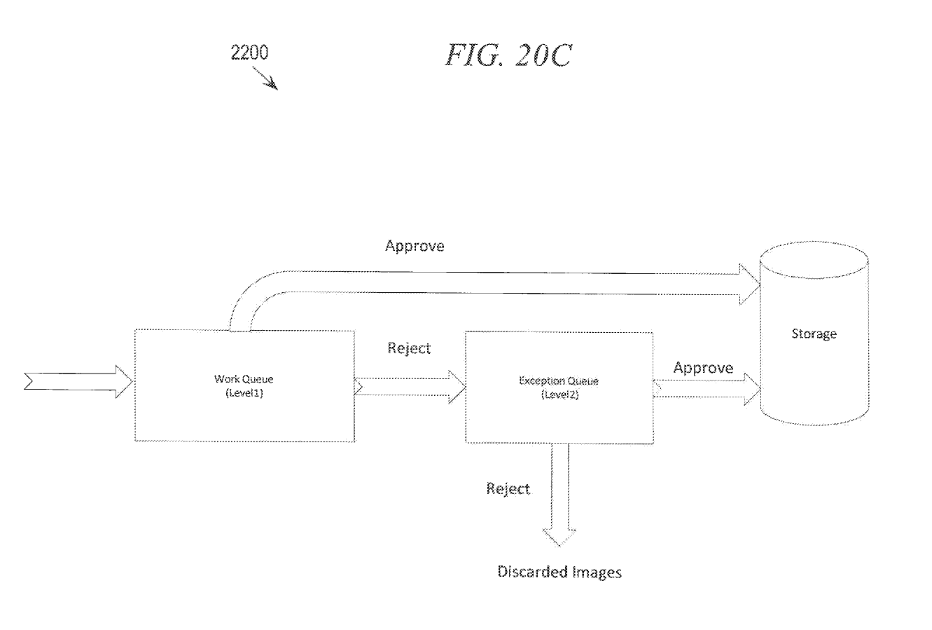

FIG. 20A depicts an example workflow 2000 for processing images. At Level 1 of workflow 2000, an image from a Work Queue is evaluated and either approved or rejected. For example, as previously described herein, image management application 164 may provide a graphical user interface that allows a user to view, from a Work Queue, images and their associated metadata, and approve or reject the images. Approved images are provided to an external system, such as EMR system 106. Rejected images are provided to an Exception Queue at Level 2 of workflow 2000 for further evaluation and/or correction. For example, an image and/or the metadata for an image may be changed or updated to correct any identified errors or to provide any missing or incomplete information. Images that are again rejected at Level 2 of workflow 200 are discarded, while images that are approved are provided to an external system, such as EMR system 106. Different levels of access may be required for Level 1 and Level 2 of workflow 200. For example, a first level of access may be required to approve or reject images in the Work Queue at Level 1, while a second and higher level of access may be required to reject or approve images in the Exception Queue at Level 2. The higher level of access may be required for Level 2, since images rejected at Level 2 are discarded.

FIG. 20B depicts an example workflow 2100 that includes all of the elements of workflow 2000 of FIG. 20A, and also includes an additional Approval Queue at Level 3 of workflow 2100. In workflow 2100, images that are approved either at the Work Queue at Level 1, or the Exception Queue at Level 2, are transmitted to an Approval Queue at Level 3. Images approved at the Approval Queue at Level 3 are transmitted to EMR system 106 and images that are rejected are discarded. The additional Approval Queue at Level 3 of workflow 2100 provides an additional level of approval that is useful in many situations, for example, when images contain sensitive information, for regulatory compliance, legal compliance, etc. A user authorized to provide the second approval of images at the Approval Queue at Level 3, may be specially-designated personnel, senior personnel, or other users authorized to provide the approval of images that will result in approved images being transmitted to EMR 106. The use of workflow levels provides great flexibility in the processing of images. For example, a first user having a first level of authority may be given access to the Work Queue at Level 1, but not the Except Queue at Level 2 or the Approval Queue at Level 3. A second user having a second level of authority may be given access to the Work Queue at Level 1 and the Except Queue at Level 2, but not the Approval Queue at Level 3. A third user having a third (and highest) level of authority may be given access to the Work Queue at Level 1, the Exception Queue at Level 2 and also the Approval Queue at Level 3. Users with access to the Approval Queue at Level 3 are not necessarily given access to the Work Queue at Level 1 or the Exception Queue at Level 2 and the access provided to users may be configured in a wide variety of ways, depending upon a particular implementation. The use of workflow levels provides a flexible and extensive approach that allows for multiple levels of access granularity. FIG. 20C depicts an example workflow 2200 that is the same as workflow 2000 of FIG. 20A, except that approved images are provided to storage, for example storage 168, instead of to EMR system 106.

### IX. Implementation Mechanisms

Although the flow diagrams of the present application depict a particular set of steps in a particular order, other implementations may use fewer or more steps, in the same or different order, than those depicted in the figures.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

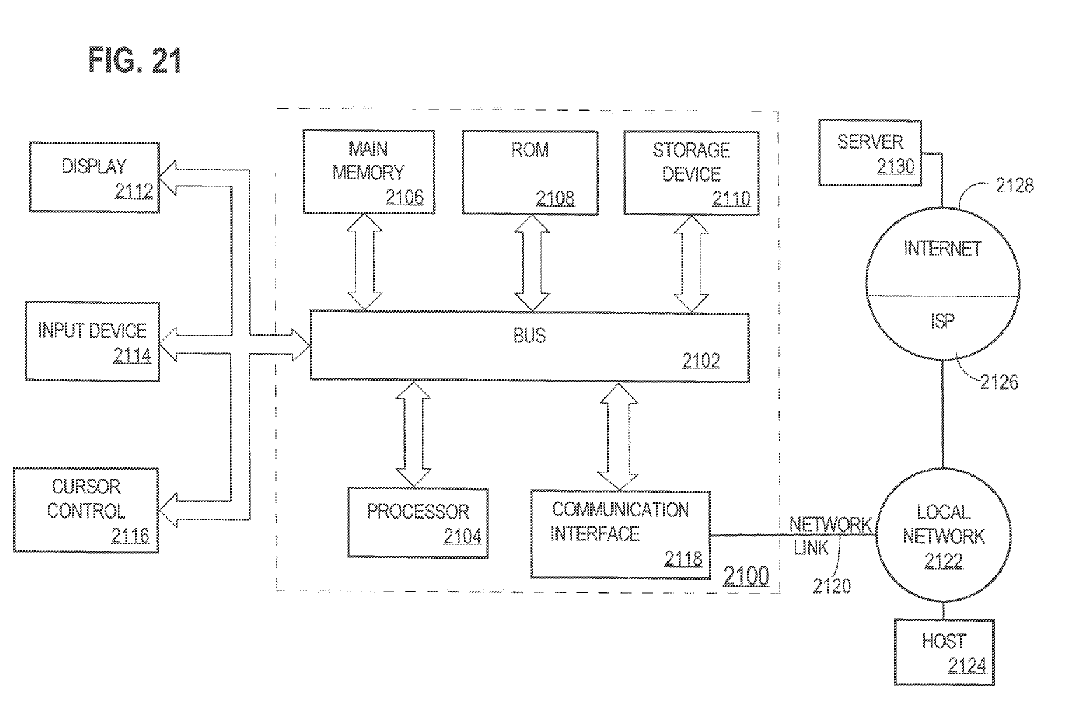

FIG. 21 is a block diagram that depicts an example computer system 2100 upon which embodiments may be implemented. Computer system 2100 includes a bus 2102 or other communication mechanism for communicating information, and a processor 2104 coupled with bus 2102 for processing information. Computer system 2100 also includes a main memory 2106, such as a random access memory (RAM) or other dynamic storage device, coupled to bus 2102 for storing information and instructions to be executed by processor 2104. Main memory 2106 also may be used for storing temporary variables or other intermediate information during execution of instructions to be executed by processor 2104. Computer system 2100 further includes a read only memory (ROM) 2108 or other static storage device coupled to bus 2102 for storing static information and instructions for processor 2104. A storage device 2110, such as a magnetic disk or optical disk, is provided and coupled to bus 2102 for storing information and instructions.

Computer system 2100 may be coupled via bus 2102 to a display 2112, such as a cathode ray tube (CRT), for displaying information to a computer user. Although bus 2102 is illustrated as a single bus, bus 2102 may comprise one or more buses. For example, bus 2102 may include without limitation a control bus by which processor 2104 controls other devices within computer system 2100, an address bus by which processor 2104 specifies memory locations of instructions for execution, or any other type of bus for transferring data or signals between components of computer system 2100.

An input device 2114, including alphanumeric and other keys, is coupled to bus 2102 for communicating information and command selections to processor 2104. Another type of user input device is cursor control 2116, such as a mouse, a trackball, or cursor direction keys for communicating direction information and command selections to processor 2104 and for controlling cursor movement on display 2112. This input device typically has two degrees of freedom in two axes, a first axis (e.g., x) and a second axis (e.g., y), that allows the device to specify positions in a plane.

Computer system 2100 may implement the techniques described herein using customized hard-wired logic, one or more ASICs or FPGAs, firmware and/or program logic or computer software which, in combination with the computer system, causes or programs computer system 2100 to be a special-purpose machine. According to one embodiment, those techniques are performed by computer system 2100 in response to processor 2104 processing instructions stored in main memory 2106. Such instructions may be read into main memory 2106 from another computer-readable medium, such as storage device 2110. Processing of the instructions contained in main memory 2106 by processor 2104 causes performance of the functionality described herein. In alternative embodiments, hard-wired circuitry may be used in place of or in combination with software instructions to implement the embodiments. Thus, embodiments are not limited to any specific combination of hardware circuitry and software.

The term “computer-readable medium” as used herein refers to any medium that participates in providing data that causes a computer to operate in a specific manner. In an embodiment implemented using computer system 2100, various computer-readable media are involved, for example, in providing instructions to processor 2104 for execution. Such a medium may take many forms, including but not limited to, non-volatile media and volatile media. Non-volatile media includes, for example, optical or magnetic disks, such as storage device 2110. Volatile media includes dynamic memory, such as main memory 2106. Common forms of computer-readable media include, without limitation, a floppy disk, a flexible disk, hard disk, magnetic tape, or any other magnetic medium, a CD-ROM, any other optical medium, a RAM, a PROM, and EPROM, a FLASH-EPROM, any other memory chip, memory cartridge or memory stick, or any other medium from which a computer can read.

Various forms of computer-readable media may be involved in storing instructions for processing by processor 2104. For example, the instructions may initially be stored on a storage medium of a remote computer and transmitted to computer system 2100 via one or more communications links. Bus 2102 carries the data to main memory 2106, from which processor 2104 retrieves and processes the instructions. The instructions received by main memory 2106 may optionally be stored on storage device 2110 either before or after processing by processor 2104.

Computer system 2100 also includes a communication interface 2118 coupled to bus 2102. Communication interface 2118 provides a communications coupling to a network link 2120 that is connected to a local network 2122. For example, communication interface 2118 may be a modem to provide a data communication connection to a telephone line. As another example, communication interface 2118 may be a local area network (LAN) card to provide a data communication connection to a compatible LAN. Wireless links may also be implemented. In any such implementation, communication interface 2118 sends and receives electrical, electromagnetic or optical signals that carry digital data streams representing various types of information.

Network link 2120 typically provides data communication through one or more networks to other data devices. For example, network link 2120 may provide a connection through local network 2122 to a host computer 2124 or to data equipment operated by an Internet Service Provider (ISP) 2126. ISP 2126 in turn provides data communication services through the world wide packet data communication network now commonly referred to as the “Internet” 2128. Local network 2122 and Internet 2128 both use electrical, electromagnetic or optical signals that carry digital data streams.

Computer system 2100 can send messages and receive data, including program code, through the network(s), network link 2120 and communication interface 2118. In the Internet example, a server 2130 might transmit a requested code for an application program through Internet 2128, ISP 2126, local network 2122 and communication interface 2118. The received code may be processed by processor 2104 as it is received, and/or stored in storage device 2110, or other non-volatile storage for later execution.

In the foregoing specification, embodiments have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A network device comprising:
one or more processors;
one or more memories; and
an image management application configured to perform:
receiving, over one or more communications links from a first client device that is external to the network device, image data and metadata for an image acquired by the first client device, wherein the metadata for the image specifies one or more logical entities for the image acquired by the first client device,
in response to receiving, over the one or more communications links from the first client device that is external to the network device, the image data and the metadata for the image acquired by the first client device, wherein the image data specifies one or more logical entities for the image acquired by the first client device, storing the image data and the metadata for the image acquired by the first client device,
receiving, over the one or more communications links from a second client device that is external to the network device and different from the first client device, a request for a user to access the image data for the image acquired by the first client device,
in response to receiving, over the one or more communications links from a second client device that is external to the network device and different from the first client device, a request for a user to access the image data and the metadata for the image acquired by the first client device:
determining one or more logical entities assigned to the user,
determining, based upon the one or more logical entities assigned to the user and the one or more logical entities for the image acquired by the first client device, whether the user is permitted to access the image acquired by the first client device,
in response to determining, based upon the one or more logical entities assigned to the user and the one or more logical entities for the image acquired by the first client device, that the user is permitted to access the image acquired by the first client device, then causing the image data and the metadata for the image acquired to the first client device to be transmitted to the second client device,
in response to determining, based upon the one or more logical entities assigned to the user and the one or more logical entities for the image acquired by the first client device, that the user is not permitted to access the image acquired by the first client device, then not causing the image data and the metadata for the image acquired to the first client device to be transmitted to the second client device.

2. The network device of claim 1, wherein determining one or more logical entities assigned to the user includes determining one or more roles assigned to the user and determining that the one or more logical entities are assigned to the one or more roles assigned to the user.

3. The network device of claim 2, wherein at least one role from the one or more roles assigned to the user are assigned to one or more other users.

4. The network device of claim 1, wherein determining one or more logical entities assigned to the user includes:
transmitting, to a service external to the network device, a request for one or more logical entities assigned to the user, and
receiving, from the service external to the network device, a response specifying that the one or more logical entities are assigned to the user.

5. The network device of claim 1, wherein the one or more logical entities assigned to the user are one or more departments of a business organization.

6. The network device of claim 1, wherein the one or more logical entities for the image acquired by the first client device are specified by one or more of a configuration of the first client device, a user of the first client device or by scanning encoded data.

7. The network device of claim 1, wherein the image management application is further configured to perform:
receiving a request to change the one or more logical entities assigned to the user, and
in response to the request to change the one or more logical entities assigned to the user, update data that specifies that the one or more logical entities are assigned to the user to represent the change specified in the request.

8. One or more non-transitory computer-readable media storing instructions which, when processed by one or more processors, cause an image management application to perform:
receiving, over one or more communications links from a first client device that is external to a network device on which the image management application executes, image data and metadata for an image acquired by the first client device, wherein the metadata for the image specifies one or more logical entities for the image acquired by the first client device,
in response to receiving, over the one or more communications links from the first client device that is external to the network device on which the image management application executes, the image data and the metadata for the image acquired by the first client device, wherein the image data specifies one or more logical entities for the image acquired by the first client device, storing the image data and the metadata for the image acquired by the first client device,
receiving, over the one or more communications links from a second client device that is external to the network device on which the image management application executes and different from the first client device, a request for a user to access the image data for the image acquired by the first client device,
in response to receiving, over the one or more communications links from a second client device that is external to the network device on which the image management application executes and different from the first client device, a request for a user to access the image data and the metadata for the image acquired by the first client device:
determining one or more logical entities assigned to the user,
determining, based upon the one or more logical entities assigned to the user and the one or more logical entities for the image acquired by the first client device, whether the user is permitted to access the image acquired by the first client device,
in response to determining, based upon the one or more logical entities assigned to the user and the one or more logical entities for the image acquired by the first client device, that the user is permitted to access the image acquired by the first client device, then causing the image data and the metadata for the image acquired to the first client device to be transmitted to the second client device,
in response to determining, based upon the one or more logical entities assigned to the user and the one or more logical entities for the image acquired by the first client device, that the user is not permitted to access the image acquired by the first client device, then not causing the image data and the metadata for the image acquired to the first client device to be transmitted to the second client device.

9. The one or more non-transitory computer-readable media of claim 8, wherein determining one or more logical entities assigned to the user includes determining one or more roles assigned to the user and determining that the one or more logical entities are assigned to the one or more roles assigned to the user.

10. The one or more non-transitory computer-readable media of claim 9, wherein at least one role from the one or more roles assigned to the user are assigned to one or more other users.

11. The one or more non-transitory computer-readable media of claim 8, wherein determining one or more logical entities assigned to the user includes:
transmitting, to a service external to the network device on which the image management application executes, a request for one or more logical entities assigned to the user, and
receiving, from the service external to the network device on which the image management application executes, a response specifying that the one or more logical entities are assigned to the user.

12. The one or more non-transitory computer-readable media of claim 8, wherein the one or more logical entities assigned to the user are one or more departments of a business organization.

13. The one or more non-transitory computer-readable media of claim 8, wherein the one or more logical entities for the image acquired by the first client device are specified by one or more of a configuration of the first client device, a user of the first client device or by scanning encoded data.

14. The one or more non-transitory computer-readable media of claim 8, wherein the image management application is further configured to perform:
receiving a request to change the one or more logical entities assigned to the user, and
in response to the request to change the one or more logical entities assigned to the user, update data that specifies that the one or more logical entities are assigned to the user to represent the change specified in the request.

15. A computer-implemented method comprising an image management application performing:
receiving, over one or more communications links from a first client device that is external to a network device on which the image management application executes, image data and metadata for an image acquired by the first client device, wherein the metadata for the image specifies one or more logical entities for the image acquired by the first client device,
in response to receiving, over the one or more communications links from the first client device that is external to the network device on which the image management application executes, the image data and the metadata for the image acquired by the first client device, wherein the image data specifies one or more logical entities for the image acquired by the first client device, storing the image data and the metadata for the image acquired by the first client device,
receiving, over the one or more communications links from a second client device that is external to the network device on which the image management application executes and different from the first client device, a request for a user to access the image data for the image acquired by the first client device,
in response to receiving, over the one or more communications links from a second client device that is external to the network device on which the image management application executes and different from the first client device, a request for a user to access the image data and the metadata for the image acquired by the first client device:
determining one or more logical entities assigned to the user,
determining, based upon the one or more logical entities assigned to the user and the one or more logical entities for the image acquired by the first client device, whether the user is permitted to access the image acquired by the first client device,
in response to determining, based upon the one or more logical entities assigned to the user and the one or more logical entities for the image acquired by the first client device, that the user is permitted to access the image acquired by the first client device, then causing the image data and the metadata for the image acquired to the first client device to be transmitted to the second client device,
in response to determining, based upon the one or more logical entities assigned to the user and the one or more logical entities for the image acquired by the first client device, that the user is not permitted to access the image acquired by the first client device, then not causing the image data and the metadata for the image acquired to the first client device to be transmitted to the second client device.

16. The computer-implemented method of claim 15, wherein determining one or more logical entities assigned to the user includes determining one or more roles assigned to the user and determining that the one or more logical entities are assigned to the one or more roles assigned to the user.

17. The computer-implemented method of claim 15, wherein determining one or more logical entities assigned to the user includes:
transmitting, to a service external to the network device on which the image management application executes, a request for one or more logical entities assigned to the user, and
receiving, from the service external to the network device on which the image management application executes, a response specifying that the one or more logical entities are assigned to the user.

18. The computer-implemented method of claim 15, wherein the one or more logical entities assigned to the user are one or more departments of a business organization.

19. The computer-implemented method of claim 15, wherein the one or more logical entities for the image acquired by the first client device are specified by one or more of a configuration of the first client device, a user of the first client device or by scanning encoded data.

20. The computer-implemented method of claim 15, wherein the image management application is further configured to perform:
receiving a request to change the one or more logical entities assigned to the user, and
in response to the request to change the one or more logical entities assigned to the user, update data that specifies that the one or more logical entities are assigned to the user to represent the change specified in the request.
